(19) United States
(12) Patent Application Publication
(10) Pub. No.: US 2026/0168969 A1
(43) Pub. Date: Jun. 18, 2026

(54) METHODS FOR SYSTEMS AND DETECTORS THEREOF INCLUDING A SEPARATION MEDIA

(71) Applicant: Tosoh Bioscience LLC, King of Prussia, PA (US)

(72) Inventors: David Thomas GILLESPIE, Pearland, TX (US); Christopher James FORMAN, Pottstown, PA (US)

(21) Appl. No.: 19/418,703

(22) Filed: Dec. 12, 2025

Related U.S. Application Data
(60) Provisional application No. 63/733,614, filed on Dec. 13, 2024.

(51) Int. Cl. G01N 30/86; G01N 30/62

(52) U.S. Cl. CPC G01N 30/8617; G01N 30/62; G01N 2030/623; G01N 2030/626

(57) ABSTRACT

Methods for a system including a detector and a separation media are disclosed. The method may include receiving input data from the detector. The input data may include an observed signal of an unknown sample and a signal of at least one known sample. The method may also include generating one or more deconvolution candidate signals based on the observed signal and using one or more deconvolution processes. The method may further include defining a domain of the detector using the one or more deconvolution processes and based on the observed signal, the calibrated separation media, the input data, or a combination thereof. The method may also include modifying the system based on the domain.

### CROSS-REFERENCE TO RELATED APPLICATIONS

This application claims priority to and the benefit of U.S. Provisional Patent Application No. 63/733,614 filed on Dec. 13, 2024, the entirety of which is incorporated herein by reference to the extent consistent with the present disclosure.

### BACKGROUND

Detectors that operate in conjunction with a separation media (e.g., packed beds, porous columns, membranes, size-based separation elements, etc.) inherently distort signals they observe. For example, as a sample passes through the separation media, dispersion, axial mixing, mass-transfer limitations, and other transport phenomena broaden and skew the underlying distribution of the sample components. Additional broadening and filtering also occur within the detector itself. The combined effect produces measured signals that differ significantly from the “true” or ground truth distribution, thereby yielding peak shifts, broadened features, blended peaks, loss of resolution, and the like. Although these problems have been recognized for decades in contexts such as column chromatography, conventional correction techniques have remained largely unchanged.

Existing approaches for correcting dispersion in detectors using separation media, such as chromatography columns, commonly rely on calibration-based transformations rather than direct correction of the detector and the output thereof. For example, the Hamielec and Yau methods used in size-exclusion chromatography (SEC) operate only for SEC columns and require molecular-weight calibration curves tied to a specific column set. Particularly, these methods transform a linear calibration curve using a parameter derived from an estimate of column dispersion, and apply the transformed curve to unmodified detector signals to generate corrected molecular-weight moments (e.g., Mw, Mn, Mz). Some systems further adjust the calibration function so that known standards return expected values. These approaches, however, merely reshape the calibration curve; they do not actively remove or counteract the dispersive effects introduced by the detector or the separation media. Their mathematical validity depends on assuming Gaussian detector broadening and Gaussian dispersion within the media-assumptions that permit factorization of the integral equations describing transport through packed beds. Even when these assumptions hold approximately, the underlying distribution remains distorted, and artifacts such as peak blending and asymmetry are not resolved. Moreover, such methods are largely limited to SEC and do not directly correct the raw, volume-based response data or signals output by the detector.

Attempts to treat dispersion in detector-and-media systems as a simple convolution of a true signal with an instrument response have also proven insufficient. Systems employing a separation media are not strictly linear or time-invariant, and their impulse-response behavior varies with analyte properties, operating conditions, loading, diffusion, and mass-transfer kinetics. As seen in chromatography, this prevents the data from satisfying the assumptions required for exact convolution and inversion. Even if such an approximation is imposed for modeling, exact deconvolution is mathematically ill-posed because realistic peak-shape functions have Fourier components that decay to near zero at high frequencies, causing inversion to amplify noise and produce unstable results. For this reason, conventional deconvolution without regularization has not been feasible, and all practical approaches rely on constrained or nonlinear approximations such as empirical peak-shape fitting, Tikhonov regularization, maximum-entropy estimation, Bayesian unmixing, or other stabilized inverse methods. These conventional techniques, however, do not directly correct the detector or the output thereof for the dispersive effects imposed by the separation media, and often introduce spurious non-physical artefacts such as ringing or dips; and thus, fail to overcome the limitations of the traditional calibration-based approaches.

What is needed, then, are systems and methods that modify, condition, or otherwise correct detectors for dispersion introduced by the detectors and separation media thereof without relying on restrictive assumptions (e.g., Gaussian), fixed calibration-curve transformations, and/or unstable deconvolution operations.

### SUMMARY

A method for determining a dispersion corrected signal with a detector including a separation media is disclosed. The method may include receiving input data including an observed signal of an unknown sample from the detector. The method may also include configuring the detector based on the input data to produce a calibrated separation media and a conditioned observed signal. The method may further include generating one or more deconvolution candidate signals based on the conditioned observed signal and using one or more deconvolution processes. The method may also include defining a domain of the dispersion corrected signal using the one or more deconvolution processes and based on the conditioned observed signal, the calibrated separation media, the input data, or a combination thereof. The method may also include reconvolving the one or more deconvolution candidate signals based on the input data, the calibrated separation media, or a combination thereof, to produce one or more reconvolved deconvolution candidate signals. The method may also include selecting an initial deconvolution candidate signal from the one or more deconvolution candidate signals based on the one or more reconvolved deconvolution candidate signals, the input data, or a combination thereof. The method may also include determining the dispersion corrected signal based on the initial deconvolution candidate and the domain.

A method for modifying a system including a detector and a separation media is also disclosed. The method may include receiving input data from the detector. The input data may include an observed signal of an unknown sample and a signal of at least one known sample. The method may also include calibrating the separation media based on the signal of the at least one known sample to produce a calibrated separation media. The method may also include generating a conditioned observed signal of the unknown sample by applying, to the observed signal of the unknown sample, a baseline correction, a filtering operation, a normalization operation, or a combination thereof. The method may also include generating one or more deconvolution candidate signals based on the conditioned observed signal and using one or more deconvolution processes. The method may also include defining a domain of the detector using the one or more deconvolution processes and based on the conditioned observed signal, the calibrated separation media, the input data, or a combination thereof. The method may also include reconvolving the one or more deconvolution candidate signals based on the input data, the calibrated separation media, or a combination thereof, to produce one or more reconvolved deconvolution candidate signals. The method may also include selecting an initial deconvolution candidate signal from the one or more deconvolution candidate signals based on the one or more reconvolved deconvolution candidate signals, the input data, or a combination thereof. The method may also include modifying the detector based on the initial deconvolution candidate signal and the domain.

A method for modifying a system including a detector and a calibrated separation media operably coupled with one another is also disclosed. The method includes receiving input data from the system. The input data may include an observed signal of an unknown sample and a signal of at least one known sample. The method also includes generating one or more deconvolution candidate signals based on the observed and using one or more deconvolution processes. The method also includes defining a domain of the detector using the one or more deconvolution processes and based on the observed signal, the calibrated separation media, the input data, or a combination thereof. The method also includes reconvolving the one or more deconvolution candidate signals based on the input data, the calibrated separation media, or a combination thereof, to produce one or more reconvolved deconvolution candidate signals. The method also includes selecting an initial deconvolution candidate signal from the one or more deconvolution candidate signals based on the one or more reconvolved deconvolution candidate signals, the input data, or a combination thereof. The method also includes modifying the system based on the initial deconvolution candidate and the domain.

A method for modifying a system including a detector and a calibrated separation media operably coupled with one another. The method includes receiving input data from the detector. The input data may include an observed signal of an unknown sample and a signal of at least one known sample. The method also includes generating one or more deconvolution candidate signals based on the observed signal and using one or more deconvolution processes. The method also includes defining a domain of the detector using the one or more deconvolution processes and based on the observed signal, the calibrated separation media, the input data, or a combination thereof. The method also includes modifying the system based on the domain.

In some examples, the input data may further include a signal of at least one known sample. In some examples, configuring the detector may include calibrating the separation media based on the signal of the at least one known sample to produce the calibrated separation media. In some examples, configuring the detector may also include determining a convolution kernel of the detector based on the calibrated separation media. In some examples, configuring the detector may also include determining a signal-to-noise ratio of the observed signal of the unknown sample. In some examples, configuring the detector may also include filtering the observed signal of the unknown sample to produce a filtered signal based on the signal-to-noise ratio, the input data, or a combination thereof. In some examples, configuring the detector may also include generating the conditioned observed signal based on the observed signal of the unknown sample, the filtered signal, or a combination thereof.

In some examples, generating the one or more deconvolution candidate signals may include applying the one or more deconvolution processes to the conditioned observed signal. Applying each deconvolution process of the one or more deconvolution processes may produce a respective deconvolution candidate signal of the one or more deconvolution candidate signals.

In some examples, the domain of the dispersion corrected signal may be a multidimensional domain defined by an N-dimensional vector space. In some examples, defining the domain of the dispersion corrected signal may include determining a convolution kernel of the detector based on the calibrated separation media. Defining the domain of the dispersion corrected signal may also include reconvolving the one or more deconvolution candidate signals based on the convolution kernel to produce the one or more reconvolved deconvolution candidate signals. Defining the domain of the dispersion corrected signal may also include generating a set of error vector for each deconvolution candidate signal of the one or more deconvolution candidate signals based on the one or more reconvolved deconvolution candidate signals and the conditioned observed signal. Defining the domain of the dispersion corrected signal may also include determining a set of N basis vectors based on the set of error vectors. Defining the domain of the dispersion corrected signal may also include defining the domain of the dispersion corrected signal based on the set of N basis vectors.

In some examples, the input data may include one or more user-defined inputs. The one or more user-defined inputs may include one or more constraints. The initial deconvolution candidate signal may be based on the one or more constraints.

In some examples, selecting the initial deconvolution candidate signal from the one or more deconvolution candidate signals may include applying the one or more constraints to each deconvolution candidate signal of the one or more deconvolution candidate signals to produce one or more respective constraint scores. Selecting the initial deconvolution candidate signal from the one or more deconvolution candidate signals may also include determining a respective composite score for each deconvolution candidate of the one or more deconvolution candidate signals based on the one or more respective constraint scores. Selecting the initial deconvolution candidate signal from the one or more deconvolution candidate signals may also include selecting the initial deconvolution candidate signal based on the respective composite score for each deconvolution candidate signal of the one or more deconvolution candidate signals.

In some examples, selecting the initial deconvolution candidate signal from the one or more deconvolution candidate signals may include: determining a respective fidelity of each deconvolution candidate signal based on the one or more reconvolved deconvolution candidate signals; and selecting the initial deconvolution candidate signal based on the respective fidelity for each deconvolution candidate signal of the one or more deconvolution candidate signals.

In some examples, the method may further include displaying an output based on the dispersion corrected signal.

In some examples, the domain may include a multidimensional domain defined by an N-dimensional vector space including a plurality of correction vectors (Cₖ).

In some examples, the plurality of correction vectors (Cₖ) may be based on a set of N basis vectors (Bᵢ).

In some examples, the plurality of correction vectors (Cₖ) may be represented by the following Equation:

$${\underline{C}}_{k} = {\sum }_{i = 1}^{N} {ρ}_{k i} {B}_{i} ,$$

where: ρₖᵢ is a set of weighting parameters; and Bᵢ is the set of N basis vectors.

In some examples, the one or more reconvolved deconvolution candidate signals may be defined based on the calibrated separation media.

In some examples, defining the domain may include generating a set of error vectors for each deconvolution candidate signal of the one or more deconvolution candidate signals based on the one or more reconvolved deconvolution candidate signals and the conditioned observed signal.

In some examples, generating the set of error vectors for each deconvolution candidate signal may include determining a respective residual between each reconvolved deconvolution candidate signal and the conditioned observed signal. Generating the set of error vectors may also include generating the vectors for each deconvolution candidate signal based on the respective residual between each reconvolved deconvolution candidate signal and the conditioned observed signal.

In some examples, defining the domain may include determining a set of N basis vectors based on the set of error vectors.

In some examples, determining the set of N basis vectors may include applying an orthonormalization process to the set of error vectors. Optionally, the orthonormalization process is a Gram-Schmidt orthonormalization process.

In some examples, defining the domain may include determining a plurality of correction vectors (Cₖ) based on the set of N basis vectors (Bᵢ), the set of error vectors, or a combination thereof.

In some examples, defining the domain may include defining the domain based on the set of N basis vectors (Bᵢ), the plurality of correction vectors (Cₖ), or a combination thereof.

In some examples, modifying the detector may include updating a parameter or protocol of the detector based on the set of N basis vectors (Bᵢ), the plurality of correction vectors (Cₖ), the set of error vectors, or a combination thereof.

In some examples, selecting the initial deconvolution candidate signal may include determining a respective composite score for each deconvolution candidate signal of the one or more deconvolution candidate signals based on the input data.

In some examples, the input data may include one or more user-defined inputs. The respective composite score for each deconvolution candidate signal of the one or more deconvolution candidate signals may be based on the one or more user-defined inputs.

In some examples, the initial deconvolution candidate signal may be selected based on at least one constraint associated with a property of the one or more deconvolution candidate signals.

In some examples, at least one constraint or the property of the one or more deconvolution candidate signals may be fidelity.

In some examples, the initial deconvolution candidate signal is selected based on the reconvolved deconvolution candidate signals.

In some examples, defining the domain may include: generating a set of error vectors for each deconvolution candidate signal of the one or more deconvolution candidate signals based on the one or more reconvolved deconvolution candidate signals and the observed signal; determining a set of N basis vectors for each deconvolution candidate signal of the one or more deconvolution candidate signals based on the respective set of error vectors thereof; and defining the domain based on set of N basis vectors.

In some examples, defining the domain may include: determining a plurality of correction vectors based on the set of N basis vectors; and defining the domain based on the plurality of correction vectors.

In some examples, the observed signal of the unknown sample may be baseline corrected, filtered, normalized, or a combination thereof.

In some examples, the method may include generating a dispersion corrected signal using the modified system.

In some examples, defining the domain of the detector may include reconvolving the one or more deconvolution candidate signals based on the calibrated separation media to produce one or more reconvolved deconvolution candidate signals.

In some examples, defining the domain may further include generating a set of error vectors for each deconvolution candidate signal of the one or more deconvolution candidate signals based on the one or more reconvolved deconvolution candidate signals and the conditioned observed signal.

In some examples, generating the set of error vectors for each deconvolution candidate signal may include: determining a respective residual between each reconvolved deconvolution candidate signal and the conditioned observed signal; and generating the set of error vectors for each deconvolution candidate signal based on the respective residual between each reconvolved deconvolution candidate signal and the conditioned observed signal.

In some examples, defining the domain may include determining a set of N basis vectors (Bᵢ) based on the set of error vectors (E_{N}).

In some examples, determining the set of N basis vectors (Bᵢ) may include applying an orthonormalization process to the set of error vectors (E_{N}). The orthonormalization process may be a Gram-Schmidt orthonormalization process.

In some examples, defining the domain may further include determining a plurality of correction vectors (Cₖ) based on the set of N basis vectors (Bᵢ), the set of error vectors (E_{N}), or a combination thereof.

In some examples, defining the domain may include defining the domain based on the set of N basis vectors (Bᵢ), the plurality of correction vectors (Cₖ), or a combination thereof.

In some examples, modifying the system may include updating a parameter or protocol of the detector based on the set of N basis vectors (Bᵢ), the plurality of correction vectors (Cₖ), the set of error vectors (E_{N}), or a combination thereof.

In some examples, the method may include generating a dispersion corrected signal using the modified system.

In some examples, a calibration curve based on the signal of the at least one known sample maintains its respective slope, concentration, or a combination thereof.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an exemplary system that may utilize or be utilized by the methods disclosed herein, according to one or more embodiments disclosed.

FIG. 2 illustrates a flowchart of an exemplary method for correcting the effects of dispersion, according to one or more embodiments.

FIG. 3 illustrates a chromatogram plotting refractive index (RI) data of a known sample through a packed bed.

FIG. 4A illustrates the isolated peak of BHT.

FIG. 4B illustrates the plot of FIG. 4A fitted with an exponentially modified Gaussian function.

FIG. 5 illustrates an exemplary chromatogram plotting RI response data of an unknown sample.

FIG. 6 illustrates a chromatogram plotting the respective RALS refractive index of each of PSS 1200 k and PSS 250 k.

FIG. 7 illustrates a chromatogram of the data from the unknown sample, and the data from the unknown sample with the tailings removed.

FIG. 8 illustrates a dispersion matrix, according to one or more embodiments.

FIG. 9 illustrates a plot of the dispersion profile at index 100 of the dispersion matrix of FIG. 8, according to one or more embodiments.

FIG. 10 illustrates a plot of an exemplary distribution of about 500,000 identical virtual beads, according to one or more embodiments.

FIG. 11 illustrates a plot of the convoluted dispersed system determined according to Equation 2, according to one or more embodiments.

FIG. 12 illustrates a plot of a measured experimental system that has been deconvoluted with a measured dispersion parameter, according to one or more embodiments.

FIG. 13 illustrates a chromatogram plotting the measured signal after normalization and interpolation, and the new signal or “pro-convolved” signal, according to one or more embodiments.

FIG. 14 illustrates a plot of the difference vector, according to one or more embodiments.

FIG. 15 illustrates a plot of the new deconvoluted vector after normalization along with respective plots of the measured signal, the PSS 1200 k, and PSS 250 k.

FIG. 16 illustrates a plot of P(v) and P*(v), according to one or more embodiments.

FIG. 17 illustrates a plot of the gradient functions, according to one or more embodiments.

FIG. 18 illustrates a plot of a deconvolution function including an inset of a residual between the deconvolution function and the ground truth, according to one or more embodiments.

FIG. 19 illustrates a plot of P(v) and P*(v), according to one or more embodiments.

FIG. 20 illustrates a plot of the gradient functions, according to one or more embodiments.

FIG. 21 illustrates a plot of a deconvolution function including an inset of a residual between the deconvolution function and the ground truth, according to one or more embodiments.

FIG. 22 illustrates an exemplary workflow of the iterative process, according to one or more embodiments disclosed.

FIG. 23 illustrates a plot of an interim function, according to one or more embodiments.

FIG. 24 illustrates a plot of an error signal derived or based on the interim function and the measured signal, according to one or more embodiments.

FIG. 25 illustrates a plot of the repeated iterations, according to one or more embodiments.

FIG. 26 illustrates a validation plot including the measured signal, the initial signal, the ground truth, and the final signal, according to one or more embodiments.

FIG. 27 illustrates a plot of molecular weights with respect to the iterations, according to one or more embodiments.

FIG. 28 illustrates an exemplary workflow for the convolve-to-deconvolve (C2D) process, according to one or more embodiments.

FIG. 29 illustrates an exemplary workflow for the shift process or method, according to one or more embodiments.

FIG. 30 illustrates a plot of output signals for a mixture containing two similar monodispersed polymers samples.

FIG. 31 illustrates a flowchart of an exemplary method, according to one or more embodiments.

FIG. 32 illustrates a computer system or electronic processor for receiving and/or analyzing data from a system or a component thereof, according to one or more embodiments.

FIG. 33 illustrates a block diagram of the computer system or electronic processor of FIG. 32, according to one or more implementations disclosed.

FIG. 34 illustrates an exemplary workflow for the moment matching process, according to one or more embodiments.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items. Further, as used herein, the term “if” may be construed to mean “when” or “upon” or “in response to determining” or “in response to detecting,” depending on the context.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

Attention is now directed to processing procedures, methods, techniques, and workflows that are in accordance with some embodiments. Some operations in the processing procedures, methods, techniques, and workflows disclosed herein may be combined and/or the order of some operations may be changed.

The present disclosure improves performance of systems and/or detectors thereof including and/or utilizing a separation media. Particularly, the present disclosure includes systems and methods for adjusting, modifying, improving, or otherwise correcting the effects of dispersion (e.g., dispersion correction) of a detector and/or a component (e.g., separation media, column, etc.) thereof. The systems and methods disclosed herein are directed to, operate on, use, or otherwise utilize directly measured data or signals from the detector in a correction process or workflow (“correction”) to adjust or correct for the effects of dispersion or band broadening independently from effects of tailing, chromatography, or a combination thereof. The dispersion processes may be characterized using measurements or signals of an output from a system (e.g., instrument, detector, etc.) including and/or utilizing a separation media, such as a packed bed, whether chromatography takes place or not. The dispersion correction disclosed herein may not be applied to the calibration curve. The dispersion correction, rather, is applied to the response signal. As such, the calibration curve may retain or maintain its essential characteristics, such as slope, concentration, or the like, or any combination thereof.

As further disclosed herein, the present disclosure improves the performance of a system and/or the detector thereof by directly correcting for band broadening or the effects of dispersions. As a result, the methods disclosed herein adjusts, modifies, improves or otherwise corrects the system or the detector thereof, thereby providing an improved, optimized, or dispersion corrected system and/or detector capable of or configured to, as compared to a respective unmodified system and/or detector (e.g., prior to correction): improve resolution between adjacent peaks (e.g., chromatogram), provide error-minimized or dispersion corrected signals without inherent detector dispersions, conduct high-throughput screening, enhance predictive capabilities via high-throughput screening, reduce a number of separation media (e.g., columns) sufficient or necessary for analysis, reduce chromatographic time, reduce chromatographic solvent, improve accuracy and/or efficacy of quantitation of analytes, enhance prediction of physical properties of macromolecules, such as rheological predictions from molecular weight, or the like, or any combination thereof.

As used herein, the term or expression “signal” may refer to a time-varying or value-varying representation of a physical quantity generated, measured, and/or output by a detector. The signal may be or include analog or digital data corresponding to responses from the detector. The responses from the detector may be or include any one or more measurable properties, such as absorbance, fluorescence intensity, mass-to charge quantity, refractive-index changes, electrical current, voltage, pressure, viscosity, or the like, or any combination thereof. The term or expression “signal” may be or include raw outputs from the detector (“detector output”), derived outputs from the detector, processed outputs from the detector, filtered outputs from the detector, transformed iterations or versions thereof, or the like, or any combination thereof. The signal may be an analog or digital representation of the detector's response to an analyte or sample. A signal may include, for example, a continuous or discrete sequence of values over time, values corresponding to the detector's measured physical properties (e.g., absorbance, emissions intensity, etc.), raw unprocessed detector outputs, process forms of the detector outputs (e.g., conditioned signals, baseline-corrected signals), normalized signals, filtered signals, reconstructed signals, etc.), or the like, or any combination thereof. The signal may be produced by any one or more sensing modalities including, but not limited to, optical, electrical, chemical, or the like, or any combination thereof. The term or expression “signal” may also include a chromatogram representing the detector output values as a function of time or any other time-resolved representation of the detector's response.

As used herein, the term or expression “separation media” may refer to a material, structure, distributed medium, substrate, or the like, configured to receive a sample and to effect at least partial separation of two or more constituents of the sample by imposing differential transport, retention, adsorption, interaction, exclusion, and/or migration behavior. The separation media may include, but is not limited to, a packed particulate bed, a porous column, a membrane, a gel matrix, a fibrous material, or any other medium that produces separation of sample components prior to detection.

As further demonstrated herein, the present inventors have surprisingly and unexpectedly discovered that the correction process or workflow disclosed herein operates for at least column chromatography. It should be appreciated, however, that since the correction process is not applied to the calibration curve, which are specific for column chromatography, the correction process disclosed herein may be equally applicable to any fluidic (e.g., liquid and/or gas) processes related to, involving, or utilizing dispersion through a separation media. As such, the correction process has a wide range of application and utility for detectors and/or fluidic processes that utilize separation media (e.g., packed-bed) in varying industries. Illustrative fluidic processes include, but are not limited to, chromatography, size exclusion chromatography (SEC), gel permeation chromatography (GPC), ion exchange chromatography, HPLC methods including reverse and normal phase chromatography, gradient systems, packed bed adsorption/desorption or crystallization techniques, such as temperature rising elution fractionation (TREF) and Thermal Gradient Interaction Chromatography (TGIC), along with gas chromatography (GC), supercritical fluid column chromatography (SFC), catalysis testing (e.g., testing the activity of catalysts for reactions, such as hydrogenation, oxidation, cracking, or the like), adsorption and desorption studies (e.g., zeolites, mesoporous materials, etc.), ion exchange processes (e.g., water softening, desalination, purification of biological samples, etc.), reactor studies (e.g., continuous flow reactors, kinetics and/or thermodynamics of reactions, etc.), filtration, distillation, gas absorption, biochemical applications (e.g., protein purification, affinity chromatography, etc.), or the like, or any combination thereof. Illustrative industries utilizing fluidic processes may include, but are not limited to, gels, solid particles, coated particles, continuous matrix systems or sintered beds, porous particles, and chemical active particles or those containing chemically active substrates, or the like.

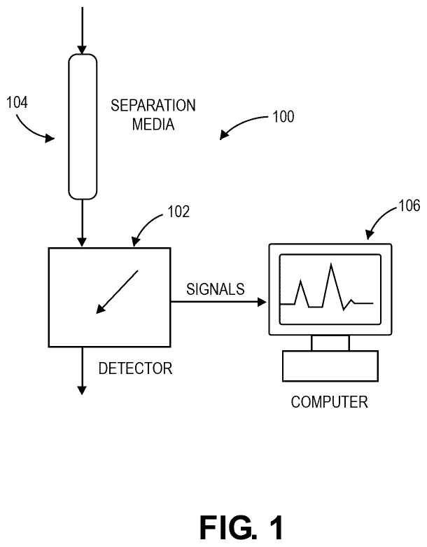

FIG. 1 illustrates an exemplary system 100 that may utilize or be utilized by the methods disclosed herein, according to one or more embodiments disclosed. The system 100 may include a detector 102, a separation media 104, a computer 106, or a combination thereof. For example, as illustrated in FIG. 1, the system 100 may include the detector 102, the separation media 104, and the computer 106 operably coupled with one another. In another example, the system may include the detector 102 and the separation media 104. In at least one implementation, the detector 102 may include the separation media 104. In another implementation, the detector 102 and the separation media 104 may be separate components of the system 100. The system 100 may be capable of or configured to process a sample containing one or more analytes. In an exemplary operation, a sample may be passed through the separation media 104 to effect a physical and/or a chemical separation of the analytes. Effluent from the separation media is directed to the detector 102. The detector 102 may be capable of or configured to receive the effluent and generate one or more signals corresponding to the detected properties. The detected properties may be or include, but are not limited to, absorbance, fluorescence, refractive-index, ion abundance, electrical response, any other measurable property, or the like, or any combination thereof. The signals may be transmitted or directed to the computer 106 or any other processing device capable of or configured to receive the signals and perform further processing, which may include any one or more of the methods disclosed herein.

In at least one implementation, the system 100 and/or a component thereof may be used to perform one or more workflows. A workflow may be a process that includes a number of steps or worksteps. A workstep may operate on data (e.g., signals), for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in software, for example, that operates on signals of the detector 102 and/or modifies the detector 102 and/or a parameter, workflow, or protocol thereof.

### General Methods

While illustrative orders for methods are disclosed herein, one having ordinary skill in the art should appreciate that one or more portions of the methods may be performed in a different order, simultaneously, repeated, or omitted. Further, at least a portion of the methods may be performed using a computing system.

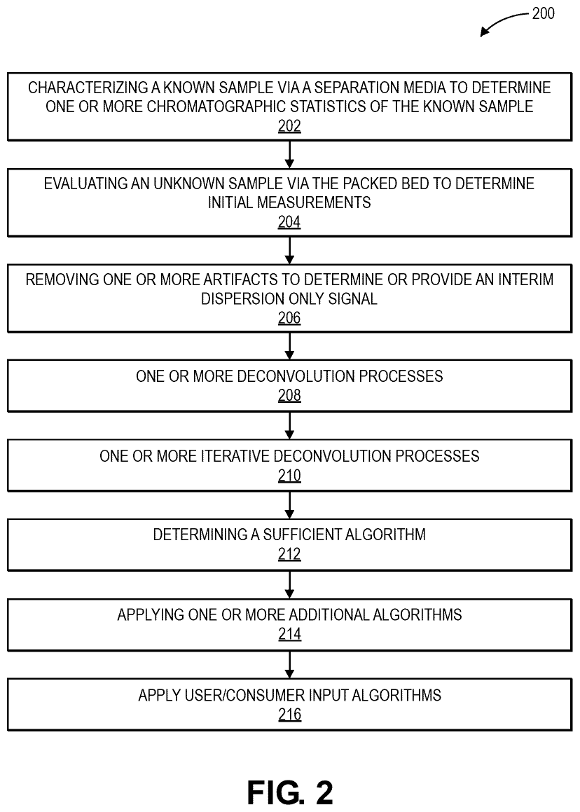

FIG. 2 illustrates a flowchart of an exemplary method 200 for correcting the effects of dispersion, according to one or more embodiments. The method 200 may include characterizing a known sample via a separation media (e.g., packed bed, packed column, etc.) to determine one or more chromatographic statistics of the known sample, as at 202. The method 200 may also include evaluating an unknown sample via the packed bed to determine initial measurements, as at 204. The method 200 may further include removing one or more artifacts to determine or provide an interim dispersion only signal, as at 206. The method 200 may also include one or more deconvolution processes, as at 208. The method 200 may also include one or more iterative deconvolution processes, as at 210. The method 200 may also include determining a sufficient algorithm, as at 212. The method 200 may also include applying one or more additional algorithms, as at 214. The method 200 may further include apply user/consumer input algorithms, as at 216. The method 200 may also include improving, optimizing, or otherwise modifying a detector and/or a component thereof (e.g., the separation media) based on any one or more of the forgoing steps.

### Characterizing a Known Sample

In at least one implementation, the method may include characterizing a sample, such as a known sample. Specifically, the method may include directing the known sample through a separation media (e.g., a packed bed), and determining or measuring chromatographic statistics, such as a width (σ_{b}) and tail (τ_{b}) of the known sample. The known sample may be a fluid (e.g., liquid or gas). The known sample may include one or more solvents or solutions and one or more analytes dispersed, mixed, combined, or otherwise disposed in the one or more solvents or solutions. The one or more analytes may be or include, but are not limited to, one or more molecules, compounds, particles, complexes, components, substances, or the like, or any combination thereof. For example, the sample may include a single analyte or a mixture of a plurality of analytes in a solvent. The chromatographic statistics may be measured without any actual and/or functional separation of the known sample on, in, or through the packed bed.

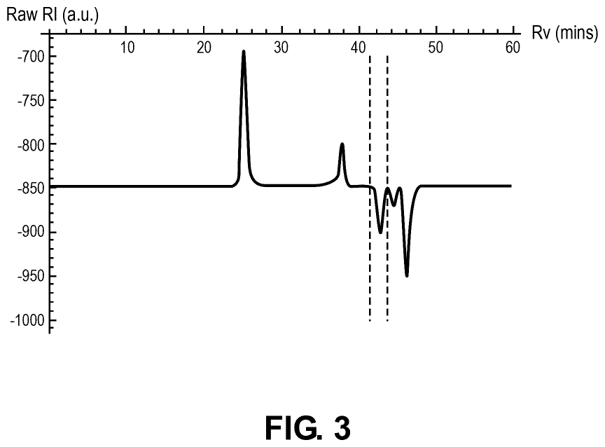

FIG. 3 illustrates a chromatogram plotting refractive index (RI) data of a known sample through a packed bed. The known sample included a mixture of a polymer in tetrahydrofuran (THF) with butylated hydroxy toluene (BHT). The polymer was a polystyrene standard polymer commercially available from Tosoh Bioscience as F-20.

As illustrated in FIG. 3, BHT may form an isolated peak (between two hashed parallel lines) representing a relatively low monodispersed molecular weight species having relatively high purity. It should be appreciated by one having skill in the art that the isolated peak shape of BHT may be due, entirely or at least in part, to dispersion effects, whereas the location of the peak may be manipulated directly by the partitioning properties of the separation column (in this case molecular size). Thus, the column resolution can be described as competing forces of the column particle partitioning power (pores) against the natural dispersive properties of the packed-bed system (availability of multiple pathways around the particles), which both lead to distribution of the analytes on the column. It should be recognized that the partitioning power of the column is the desired “result”, whereas the dispersive effect creates an undesirable “broadening” of the true distribution; the latter in this case is a single retention square wave relative to the analyte injection volume which was placed in-line with the column.

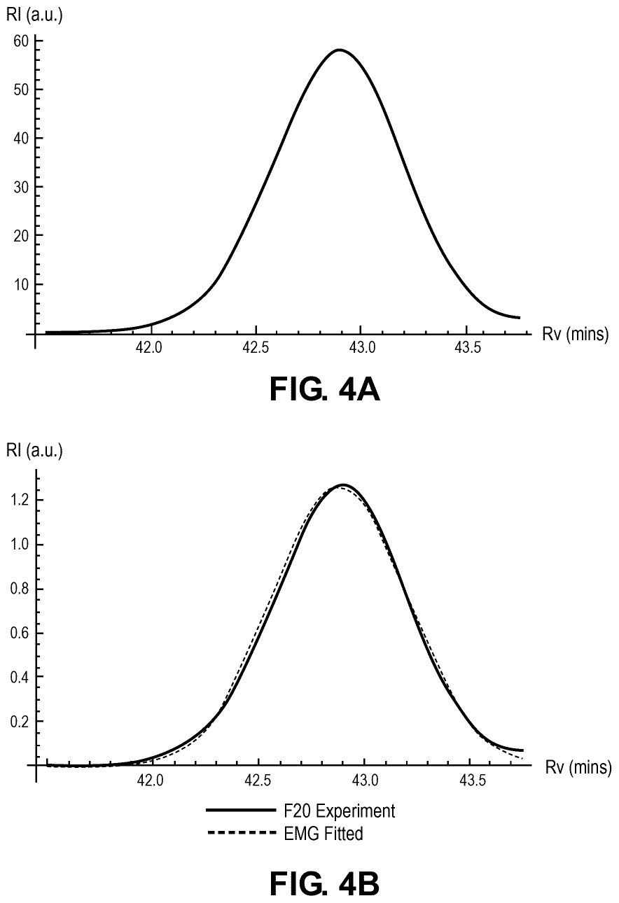

FIG. 4A illustrates the isolated peak of BHT. As illustrated in FIG. 4A, the isolated peak of BHT may be inverted and/or translated along the y-axis such that a first point of the isolated peak of BHT may be disposed at zero. The isolated peak of BHT may be normalized between the limits such that its area is about 1.

FIG. 4B illustrates the plot of FIG. 4A fitted with an exponentially modified Gaussian function. As noted above, the method may include characterizing the sample by determining or measuring chromatographic statistics of the sample. In one example, illustrated in FIG. 3, the method may include fitting an exponentially modified Gaussian function (EMG) to the data and utilizing the fitted EMG to determine or extract one or more parameters or chromatographic statistics of the sample via Equation (1). Illustrative parameters or chromatographic statistics of the sample may be or include, but are not limited to, a width (σ_{b}), a tail (τ_{b}), position (μ), or the like, or any combination thereof. The chromatographic statistics of the known sample are summarized in Table 1. Since BHT is a single molecular compound, the desired expectation from the chromatographer would be a very narrow single-square wave output, but the observed width and tail convey the magnitude of the lateral chromatographic broadening and skewness as “extra-column effects” (ECE).

$$E M G ( λ , σ , μ , v ) = \frac{1}{2} λ {e}^{\frac{1}{2} λ ( λ {σ}^{2} + 2 μ - 2 v )} erfc ( \frac{λ {σ}^{2} + μ - v}{\sqrt{2} σ} ) \qquad ( 1 )$$

TABLE 1

| Parameter | Estimate | Standard Error | Confidence Interval |
|---|---|---|---|
| μ | 0.88 | 0.00046 | {0.8807, 0.8825} |
| σ | 0.32 | 0.00022 | {0.3166, 0.3174} |
| λ | 107.89 | 4.40 | {99.18, 116.46} |

Regarding Equation (1), σ may represent a standard deviation of the Gaussian component, which may be the width parameter of the EMG. In at least one implementation, the σ parameter or value may be used to determine a measure of band broadening of the packed bed (e.g., column) utilized. For example, the σ value may be used directly as a measure of the band broadening of the packed bed. As illustrated in Table 1, the σ value was about 0.32 min, measured at a flow rate of about 1 ml/min. Accordingly, a value for dispersion (σ_{b}) in the column may be about 0.32 mL.

In at least one implementation, the λ parameter or value may be used to determine an independent estimate of the tailing and/or skewness (e.g., positively or negatively skewed) of the distribution. The independent estimate of the tailing and/or skewness of the distribution may be utilized to determine one or more corrections for the distribution. For example, the independent estimate may be utilized to correct for exponential dispersive effects due to a flow field, which may occur in systems that undergo or experience laminar flow. Such exponential dispersive effects may occur in the column itself and also in any interconnected chromatography tubing, detector cells, or even electrical capacitance discharge from the detector electronics (all of which can contribute to the sum of the ECE).

### Evaluating an Unknown Sample

The method may also include evaluating an unknown sample through the separation media (e.g., packed bed) to determine initial measurements. Illustrative initial measurements may be or include, but are not limited to, one or more of right angle light scattering (RALS), low angle light scattering (LALS), high angle light scattering (HALS), refractometer (RI), or the like, or any combination thereof. The unknown sample may include one or more analytes in a solvent. For example, the unknown sample may include a single analyte or a mixture of a plurality of analytes in a solvent. The unknown sample may be run through the same separation media (e.g., packed bed, column, etc.) as used for characterizing the known sample.

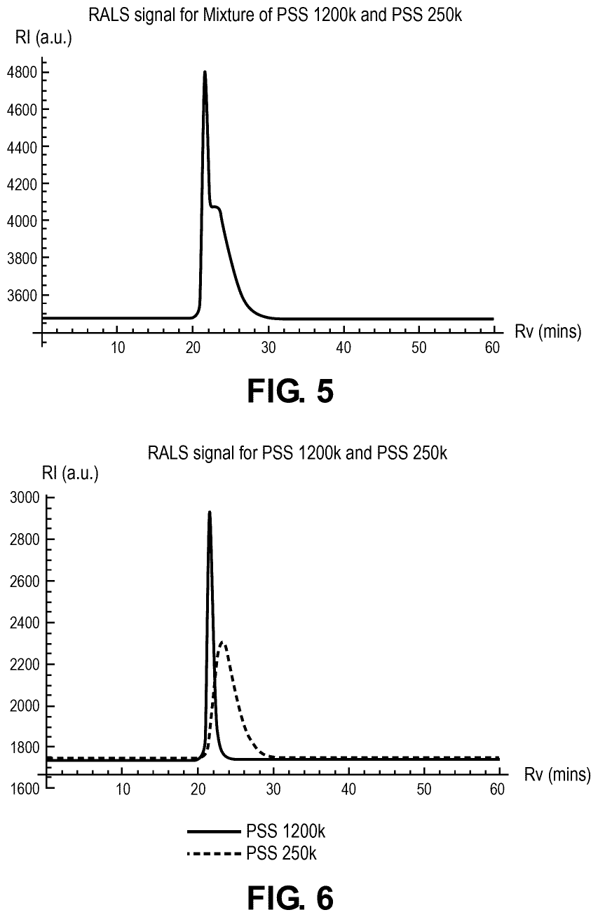

FIG. 5 illustrates an exemplary chromatogram plotting RI response data of an unknown sample. The RI may provide a linear response to the concentration of the analyte in solution as it passes from the column outlet. Specifically, FIG. 5 illustrates a chromatogram plotting the RALS response data of the unknown sample, whereby the RALS detector provides a complex product (composite signal) of the concentration, molecular weight, and molecular size of the analyte in solution as it passes from the column outlet. The unknown sample was a mixture of a very high MW polystyrene polymer standard possessing a narrow distribution of molecular weight around approximately 1,200,000 Da, namely, PSS 1200 k polymer, and a polystyrene polymer standard possessing a broad distribution of molecule weight molecules at a lower average molecular weight of approximately 250,000 Da, namely, PSS 250 k, both of which are commercially available from Polymer Standard Services (PSS), GMBH. It should be appreciated that the PSS 250 k was a broadband sample; and thus, much of its visual dispersion (broader breadth) is caused by the desirable column separation, whereas the visual dispersion (breadth) of the PSS 1200K sample was due to the packed bed dispersion. However, it should be understood, that in this instance a narrow standard of 1,200,000 and 250,000 Daltons would have nearly identical peak shape but would have separate elution volumes, corresponding, in this case to the size-difference of the molecules and the pore distribution which provides the SEC separation.

FIG. 6 illustrates a chromatogram plotting the respective RALS refractive index of each of PSS 1200 k and PSS 250 k. As illustrated in the RALS chromatogram of FIG. 6, the individual refractive index of each of PSS 1200 k and PSS 250 k both exhibited dispersion effects, similar to FIG. 5.

### Removing Exponential Tailing Artifacts (Optional)

In at least one implementation, the method may also include removing one or more ECE artifacts to provide an interim signal that would require only a dispersion correction. For example, the method may include removing one or more exponential tailing artifacts to provide the interim distribution and dispersion broadened signal. In another implementation, the method may exclude removing the one or more artifacts. Removing the one or more exponential tailing artifacts may provide a Gaussian dispersion or distribution with a one-sided tail removed or with one tail removed. Removing the one or more exponential tailing artifacts may include a deconvolution process, a smoothing or filtering process, or a combination thereof. For example, removing the one or more exponential tailing artifacts may include deconvolution. In another example, removing the one or more exponential tailing artifacts may include smoothing or filtering via one or more algorithms to remove “white noise” during, before or after the deconvolution process. In yet another example, removing the exponential tailing artifacts may include a combination of deconvolution and smoothing/filtering. For example, removing the exponential tailing artifacts may include a numerical deconvolution that includes a smoothing or filtering algorithm in a single-step process. The single-step process for deconvoluting and smoothing/filtering may allow piecewise sampling of the differential encompassing multiple datapoints, including data fitting and rejection to improve accuracy of points and their derivatives. It should be appreciated, however, that multi-step processes are also contemplated.

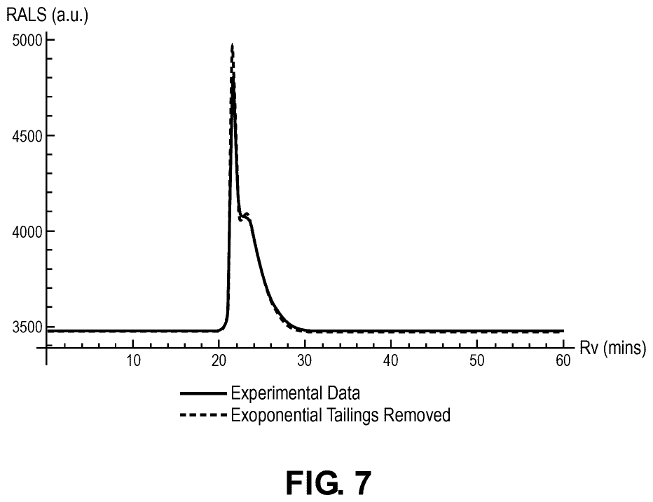

FIG. 7 illustrates a chromatogram of the data from the unknown sample, and the data from the unknown sample with the tailings removed. In at least one implementation, the scale of an exponential tail exponent may be utilized to determine the tailing from this signal of the BHT. For example, the scale of the exponential tail exponent may be utilized as an estimate of the tailing from the BHT signal utilized to previously fit the EMG. The estimated tailing may be removed through direct deconvolution, as shown in FIG. 7. It should be appreciated that removing the exponential tailing (or fronting) artifacts may be independent of the normal distribution that may represent or that may be inherent to the packed bed dispersion. Furthermore, the algorithm may remove some or all of the tailing that was determined from a mono-dispersed standard in regards to the packed bed separation process (physical, chemical, or other). Finally, the exponential tail removal therefore does not require that a mono-dispersed analyte be run or analyzed prior to the removal of an exponential term. It should be noted that although this example demonstrates the removal of an exponential term, other ECE artifacts can likewise be characterized and removed in this process if they are consistently described for the separation media (e.g., packed bed) as either a constant function with elution or as a variable function with elution.

### Deconvolution Processes

The method may further include one or more deconvolution processes. The one or more deconvolution processes may be applied to or utilized with a measured or observed signal (Mₛ(v)) to provide a deconvolved signal (S*(v)). The one or more deconvolution processes may be or include, but are not limited to, one or more of (1) a generalized inverse matrix process; (2) a convolve-to-deconvolve process; (3) a shift process; (4) a matching process; (5) a direct exponentially modified gaussian (EMG) fitting process; or any combination thereof. It should be appreciated that any other deconvolution processes may be utilized and are contemplated.

### Generalized Inverse Matrix Process

In at least one implementation, the one or more deconvolution processes may be expressed as or may include the generalized inverse matrix process. It should be appreciated that an ideal packed bed or chromatography column may separate an input mixture of one or more substances (e.g., chemicals, compounds, analytes, etc.) into a plurality of separate or distinct “slices”. The dispersion artifacts associated with a packed bed (e.g., packed column) may have the effect of remixing the plurality of distinct slices with one another. In at least one implementation, a sufficiently or well-packed bed may have the effect of remixing the plurality of distinct slices with a Gaussian process. The Gaussian process may be expressed or modeled as a matrix with one or more exponential terms. Each of the exponential terms may represent an amount or “how much” of a first distinct slice may be mixed with one or more of the remaining distinct slices. For example, each of the exponential terms may represent how much a first distinct slice is mixed with any one or more of the remaining distinct slices, based on a distance between the first distinct slice and any one or more of the remaining distinct slices (e.g., a second slice, a third slice, a fourth slice, etc.). While the foregoing describes a Gaussian relationship, it should be appreciated that other factors and/or parameters may be considered, including, but not limited to, the packing of the column, such as a particle size distribution, one or more bed dimensions, particle shape, or the like, or any combination thereof.

In at least one implementation, the generalized inverse matrix process may utilize a series, such as a discrete series, of sampled or measured data points obtained or measured at a predetermined sampling rate, which may be a uniform or a variable sampling rate. Variable sample rates may be interpolated to a uniform sample rate. Each of the measured data points for each of the plurality of distinct slices may be, related to, or may be utilized to determine a packed bed or column-dispersed chromatic weight for the respective distinct slice. The column-dispersed chromatic weight for each of the distinct slices may represent or be utilized as a component in a vector [symbol] s={Mₛ_{₁}, Mₛ_{₂}, . . . , Mₛ_{ₙ}}, as indicated in Equation (2):

$${M}_{{s}_{i}} = {Δ}_{ij} {S}_{j} \qquad ( 2 )$$

where [symbol] ₛ may be the measured chromatogram, and where vector [symbol] ={S₁, S₂, . . . , Sₙ} may represent a respective undispersed chromatic weight Sⱼ of each of the plurality of distinct slices, and where Δᵢⱼ may represent a matrix. The matrix Δᵢⱼ may represent or be utilized to determine a dispersion process or a real dispersion process inherent in the packed bed.

In at least one implementation, the matrix (Δᵢⱼ) may be expressed using Gaussian terms, as represented by Equation (3):

$${Δ}_{i j} = \frac{{e}^{- \frac{{( r ( i - j ) )}^{2}}{2 {σ}_{b}^{2}}}}{\sqrt{2 π} {σ}_{b}} \qquad ( 3 )$$

where σ_{b} may be the dispersion in units of milliliters (mL), as previously determined (See step 1), and r may be the increments of sampling between successive slices in units of mL (i.e., the reciprocal of the sample rate).

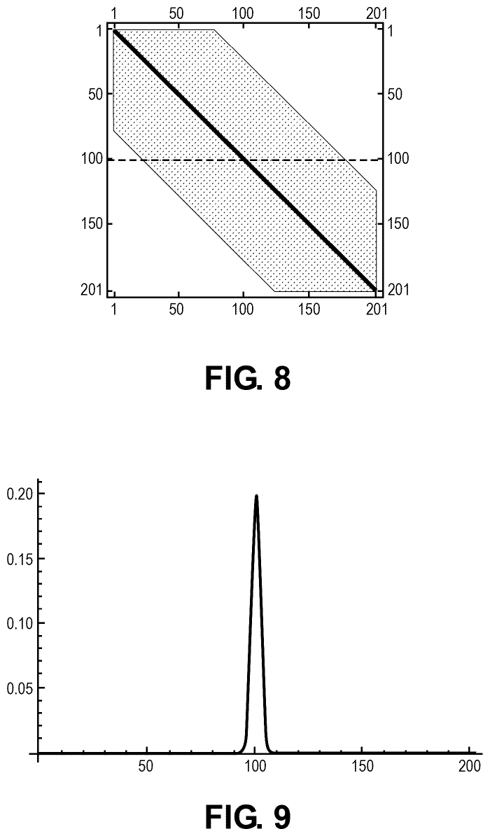

In at least one implementation, the dispersion arising from a packed bed may be characterized or encode-characterized in a matrix. The matrix may map how each input fraction mixes with all the other input fractions, with slice to slice weightings, to yield final output fractions. FIG. 8 illustrates a dispersion matrix where each row represents the extent of dispersion from each of 201 input fractions. The hashed line of FIG. 8 disposed or positioned at row 100 may represent how the contents of bin 100 are distributed in neighboring bins. Summing down the columns may represent a local mixing of subsets of the 201 bins. FIG. 9 illustrates a plot of the dispersion profile at index 100 of the dispersion matrix of FIG. 8, according to one or more embodiments. The plot represents a one-dimensional slice of the dispersion matrix taken at index 100, which illustrates the distribution profile applied to materials originating from the retention-volume bin. The plot shows a Gaussian-shaped curve centered at the selected bin, demonstrating how the contents of the bin may be proportionally dispersed into neighboring bins according to the modeled band-broadening function. Different rows of the matrix encode the mixing for different parts of the separation medium.

The second figure presents a one-dimensional slice of the dispersion matrix taken at index 100, illustrating the distribution profile applied to material originating from that retention-volume bin. The plot shows a Gaussian-shaped curve centered at the selected bin, demonstrating how the contents of that bin are proportionally dispersed into neighboring bins according to the modeled band-broadening function.

The plot of the dispersion matrix of FIG. 8 may be realized from Equation 3, by specifying or measuring values for the dispersion (σ_{b}) and the sample resolution (r). In this example, the dispersion may be σ_{b}=2 and the sample resolution may be r=1. In principle, other versions of Equation 3 may exist that denote the strength of the relationship between each of the plurality of slices in the Gaussian mixing process. Such expressions may have significantly more complex entries that may increase the linear independence of the row space, rendering the system non-singular and increasing the ability to find finite sets of solutions for the deconvolution by inverting the matrix.

A vector

$${\vec{S}}^{*} = \{ {S}_{1}^{*} , {S}_{s}^{*} , … , {S}_{n}^{*} \}$$

may be defined as a de-convolved or deconvoluted chromatogram. Assuming the presence of an inverse matrix for Δ, the components of [symbol] may be determined or computed according to Equation (4).

$${S}_{j}^{*} = {Δ}_{ji}^{- 1} {M}_{s i} = {Δ}_{jk}^{- 1} {Δ}_{k l} {S}_{l} = {δ}_{jl} {S}_{l} = {S}_{j} \qquad ( 4 )$$

It should be appreciated that the system represented by Equation (4) may be ill-posed, may not sufficiently represent, or may not meet one or more conditions of a deconvoluted distribution. For example, one or more rows of the matrix Δ may be linearly dependent; and thus, may be singular. For example, there may be no inverse; and thus, an infinite number of numerical solutions may be possible for the matrix Δ. It should be appreciated that the infinite number of numerical solutions for the matrix Δ may represent at least one reason the present disclosure directed to deconvolution has not been further pursued, developed, or further evaluated for packed beds, such as chromatography and the chromatography industry. The relatively small with respect to r, the [symbol] and Δ⁻¹ may be determined. In at least one implementation, the determination of [symbol] and Δ⁻¹ may include one or more assumptions. For example, the determination may include one or more assumptions about the functional form of the dispersion, as determined by detailed knowledge about a specific system.

Equation (5) may represent an estimate of a deconvoluted distribution, such as a deconvoluted molecular weight distribution.

$${S}_{j}^{*} = {Δ}_{j i}^{- 1} {M}_{s i} \qquad ( 5 )$$

It should be appreciated, however, that Equation (5) may also represent a deconvoluted distribution of another chromatographically, separated property, such as charge, size, or the like, or any combination thereof, or indeed the deconvoluted signal of an arbitrary signal from any kind of system, in which a Gaussian process has mixed an initial vector of inputs.

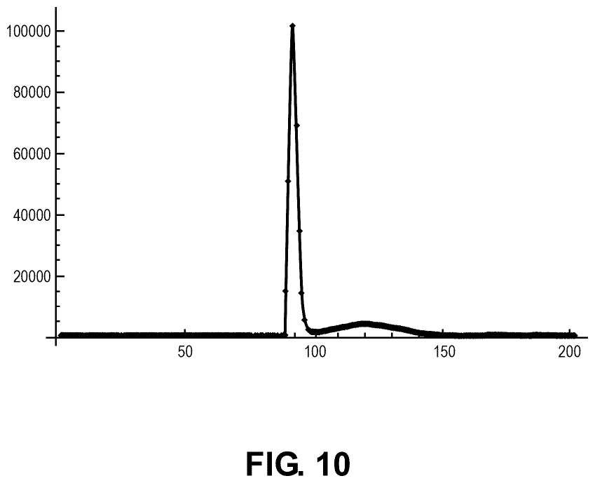

FIG. 10 illustrates a plot of an exemplary distribution of about 500,000 identical “virtual beads” that have been separated into 201 containers, bins, or groupings. As illustrated in FIG. 10, the plot includes two distributions that represent a single compound distribution. Particularly, FIG. 10 includes a Poisson distribution at about bin 90 and a wide Gaussian distribution at about bin 120. As further discussed below, to demonstrate deconvolution via an inversion matrix or via the inverse matrix process, the distribution of FIG. 10 may be convolved with a known dispersion matrix such as Equation 3 (shown as FIG. 8), which imposes further mixing on the bins.

In at least one implementation, the dispersed system may be determined with the dispersion matrix (Δᵢⱼ) and the known distribution (Sⱼ). For example, the dispersed system may be determined with the dispersion matrix (Δᵢⱼ) and the known distribution (Sⱼ) via Equation (2). Particularly, the dispersion matrix (Δᵢⱼ) may be matrix multiplied by the known distribution (Sⱼ) to determine or compute the dispersed system with a theoretical dispersion from a packed bed system.

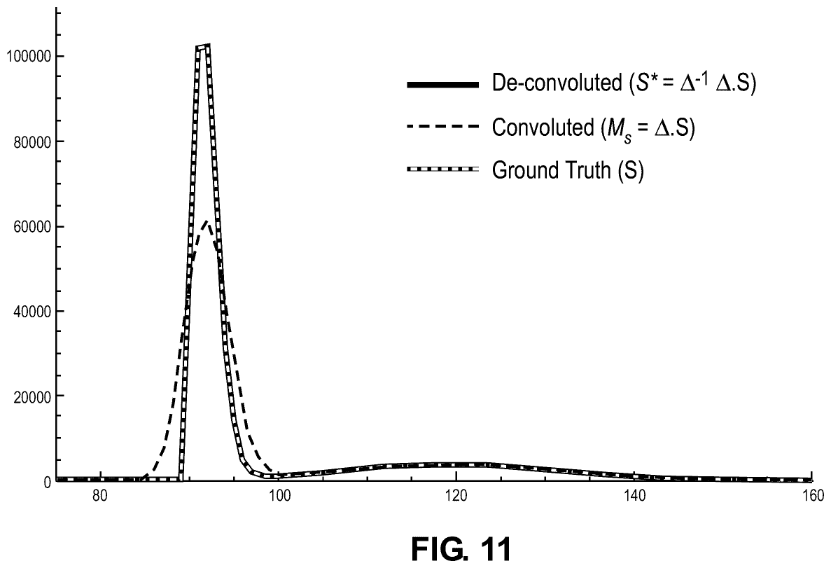

FIG. 11 illustrates a plot of the convoluted dispersed system determined according to Equation (2), as illustrated by a line of long dashes. The convoluted dispersed system may be analogous to the measured or observed chromatographic signal by or from a detector of a system (e.g., the chromatograph). FIG. 11 also illustrates a plot of a ground truth ( [symbol] ) and a deconvoluted dispersed system, as illustrated by a line of short dashes and a solid line, respectively. The ground truth signal may be recovered with the inverse of the matrix (Δ⁻¹) and the dispersed data distribution ( [symbol] ). For example, the ground truth may be determined with the inverse of the matrix (Δ⁻¹) and the dispersed data distribution ( [symbol] ) via numerical or analytical means.

It should be appreciated that if an inverse matrix that is dependent, at least in part, on the measured dispersion parameter (σ_{b}) may be identified or determined for the specific column, then the inverse matrix may be applied to a measured signal to determine the ground truth ( [symbol] ), namely, a blind or estimated ground truth ( [symbol] ). As illustrated in FIG. 11, the inverse matrix was utilized to determine or recover the exact or precise initial ground truth ( [symbol] = [symbol] ).

As discussed above, in at least one implementation, the inverse matrix (Δ⁻¹) may be determined with one or more assumptions. In another implementation, the inverse matrix (Δ⁻¹) may be determined via another process and/or calculation. For example, the inverse matrix (Δ⁻¹) may be determined via singular value decomposition (SVD), pseudo-inverse regularization, Tikhonov Regularization, other decomposition methods, or the like, or any combination thereof. Any one or more of the foregoing methods or processes to determine the inverse matrix (Δ⁻¹) allows for utilizing user provided detailed knowledge about specific systems (e.g., user-defined inputs) concerning chromatography and packed processes concerning the nature of the relationships between the dispersed slices. In this way with prior information, we can sometimes find solutions in the infinite space of solutions that are constrained with system parameters to yield realistic estimates for the true molecular weight distributions, and other quantities measured using packed beds.

In at least one implementation, determining the inverse matrix (Δ⁻¹) via the singular value decomposition (SVD) may include decomposing the matrix (Δ) into at least three matrices. For example, for SVD, the matrix (Δ) may be decomposed into two orthogonal matrices (Y) and (Z) and a diagonal matrix (D), as indicated by Equation (6). The orthogonal matrices (Y) and (Z) may be transposed to determine the inverse matrices (Y^{T}) and (Z^{T}), respectively. The diagonal matrix (D) may be singular thereby including singular eigenvalues along its diagonal. It should be appreciated that the presence of one or more zero singular values may render the matrix (D) inverseless. For example, upon dividing by the matrix or multiplying by the inverse matrix the zero singular values may amplify noise. The SVD process may identify significant dimensions of the matrix to enable or allow a signal to be reconstructed.

$${M}_{S} = Δ \cdot S = Y \cdot D \cdot {Z}^{T} \cdot S \qquad ( 6 )$$

Equation (7) represents the determination of the distribution (S) derived from Equation (6), where the inverse of the diagonal matrix (D) may be represented by [symbol] , and where each diagonal component or element is the reciprocal. We may only perform the matrix multiplications for the non-zero diagonal values by setting to zero those reciprocals that correspond to rows above the rank of the matrix Δ.

$$Z \cdot {D}_{< \cdot .} {Y}^{T} \cdot {M}_{S} = S \qquad ( 7 )$$

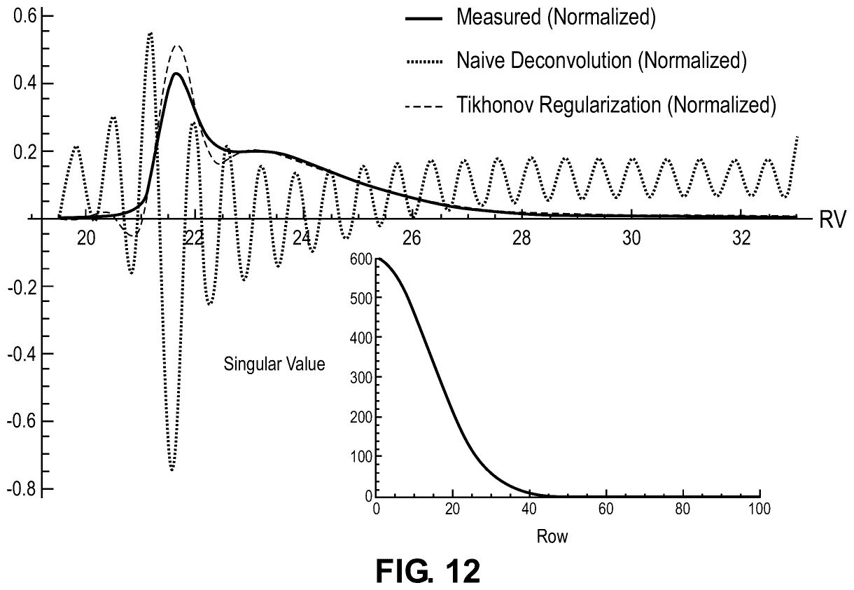

FIG. 12 illustrates a plot of a measured experimental system that has been deconvoluted with a measured dispersion parameter. As illustrated in FIG. 12, the naïve SVD plot may result in ringing, which may be an artifact from noise amplification. The Tikhonov Regularization plot may exhibit improvements; but may also result in unphysical artifacts, as illustrated in the dip below the x-axis in FIG. 12. It should be appreciated by those having ordinary skill in the art that, based on the measured RI and especially the RALS that the expected result would give a deconvolution at or above zero at all observable points.

In at least one implementation, the artifacts resulting from the filtered singular values may be countered, addressed, or corrected via one or more regularization processes. For example, the artifacts from the filtered singular values may be countered via Tikhonov Regularization. The Tikhonov Regularization may include adding or constructing a set of additional regularization terms or relations that impose one or more predetermined or desirable constraints. Accordingly, in at least one implementation, the matrix system may be transformed or modified by adding a regularization matrix and/or applying SVD to the composite. In one example, the one or more constraints may include equalizing a respective weight (a) of each of the plurality of slices of the chromatogram, as indicated in Equation (8). This manifests as mapping each singular value to a new value, as determined in Equation (9). When we do this, we constrain the solutions that can be recovered to reflect the new relationships imposed by transforming Δ.

$$Δ \to Δ + α I , \qquad ( 8 )$$

$$\frac{1}{{d}_{i}} \to \frac{{d}_{i}}{{α}^{2} + {d}_{i}^{2}} , \qquad ( 9 )$$

where dᵢ may be values between −∞ and −∞, α may be between −∞ and −∞.

In a similar way additional matrices besides may be added to Δ to thereby provide more regularized matrix (Δᵣ).

$${Δ}_{r} = Δ + α I + β I {β}^{†} \qquad 10$$

### Convolve-to-Deconvolve (C2D) Process

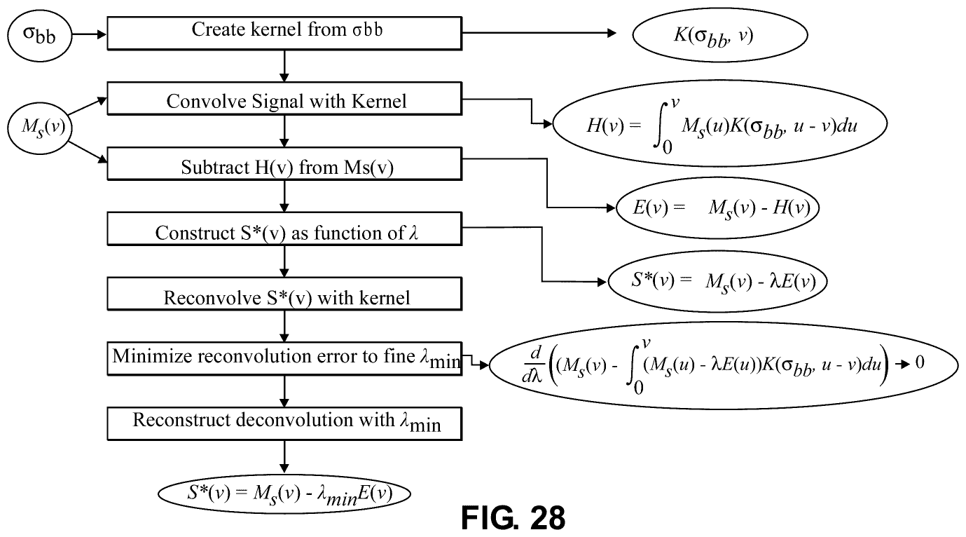

FIG. 28 illustrates an exemplary workflow for the convolve-to-deconvolve (C2D) process or method, according to one or more embodiments. In at least one implementation, the deconvolution process may include the convolve-to-deconvolve (C2D) process. As further described herein, the C2D process may include determining a new signal or function (H(v)) by convolving the measured or observed signal (Mₛ(v)). The C2D method may also include determining a difference vector (E(v)) with the new signal or function (H(v)) and the measured or observed signal (Mₛ(v)). The C2D method may further include determining a new deconvoluted vector (S*(v)) by adding a linear multiple of the difference vector (λE(v)) to the measured or observed signal (Mₛ(v)).

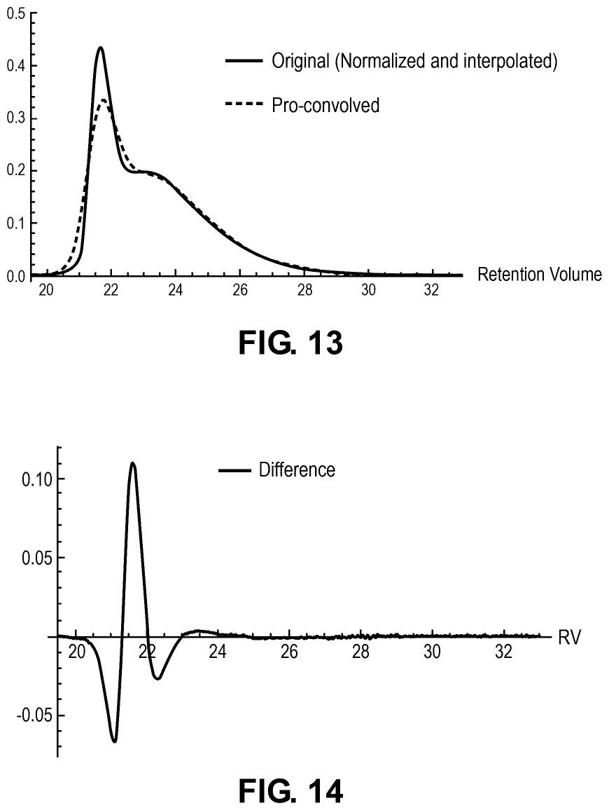

As noted above, the C2D process may include determining the new signal or function (H(v)) by convolving the measured or observed signal (Mₛ(v). The measured signal (Mₛ(v)) may be convolved with a Gaussian component. For example, the measured signal (Mₛ(v)) may be convolved with a Gaussian component, such as the band broadening component (σ_{b}), to determine the new signal (H(v)). FIG. 13 illustrates a chromatogram plotting the measured signal (Mₛ(v)) after normalization and interpolation, and the new signal or “pro-convolved” signal (H(v)). As illustrated in FIG. 13, the new signal (H(v)) may have a relatively greater dispersion than the measured signal (Mₛ(v). The new signal (H(v)) may be represented by Equation (10).

$$H ( v ) = {\int }_{- l}^{v + l} \frac{{M}_{s} ( v ) {e}^{\frac{- {( v - y )}^{2}}{2 {σ}_{{b}^{2}}}}}{{σ}_{b} \sqrt{2 π}} d y \qquad ( 10 )$$

The C2D process may also include determining a difference vector (E(v)) with the new signal or function (H(v)) and the measured or observed signal (Mₛ(v). In at least one implementation, determining the difference vector (E(v)) with the new signal (H(v)) and the measured or observed signal (Mₛ(v) may include subtracting the new signal (H(v)) from the measured signal (Mₛ(v)). For example, the difference vector (E(v)) may be expressed or determined by Equation (11).

$$E ( v ) = {M}_{s} ( v ) - H ( v ) \qquad ( 11 )$$

FIG. 14 illustrates a plot of the difference vector (E(v)). The difference vector (E(v)) may be capable of or configured to identify one or more of the slices in the dispersion of the signal that may have relatively greater importance as compared to the remaining slices. In at least one implementation, the difference vector (E(v)) may be simplified, modified, or corrected with one or more processes.

In at least one implementation, a regularized matrix (Δᵣ) may be determined by including information from the difference vector (E(v)) with a Tikhonov Regularization Matrix by using the differences from the pro-convolution to implement or impose constraints during deconvolution. In one example, the Tikhonov Regularization may include a convolution kernel, such as a Gaussian kernel, a linear kernel, a polynomial kernel, a sigmoid kernel, an exponential kernel, a rational quadratic kernel, a Laplace kernel, a cosine similarity kernel, an ANOVA kernel, or the like, or any combination thereof. The regularized matrix may be solved with one or more processes, such as a SVD process, any other kind of matrix decomposition process, such as Cholesky Decomposition, an iterative process, or the like, or any combination thereof.

The C2D process may further include determining the new deconvoluted vector (S*(v)) with the difference vector (E(v)). For example, determining the new deconvoluted vector (S*(v)) with the difference vector (E(v)) may include utilizing a parameter or a predetermined parameter (λ) to modify the difference vector (E(v)) with one or more mathematical operations or functions. In at least one implementation, determining the new deconvoluted vector (S*(v)) may be expressed according to Equation (12). For example, the new deconvoluted vector (S*(v)) may be determined by multiplying the difference vector (E(v)) by the parameter (λ) and subtracting that from the measured signal (Mₛ(v)). The parameter (λ) or a value thereof may be determined, at least in part, by one or more predetermined constraints. The one or more predetermined constraints may satisfy Equation (2) and may be or include, but are not limited to, the minimal least squares deviation from a ground state. In one example, the value of the parameter (λ) may be about 2.

$${S}^{*} ( v ) = {M}_{s} ( v ) - λ E ( v ) \qquad ( 12 )$$

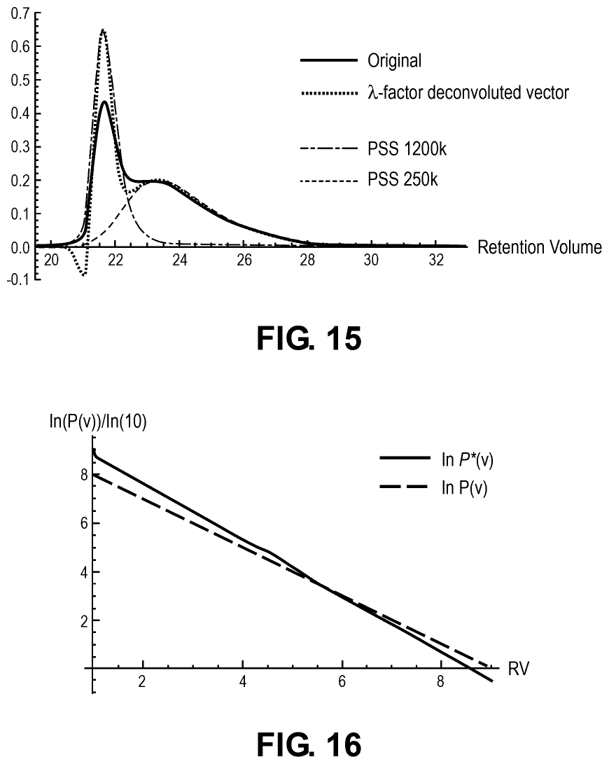

In at least one implementation, the new deconvoluted vector (S*(v)) or the λ-scaled correction vector may be normalized. FIG. 15 illustrates a plot of the new deconvoluted vector S*(v)) or the λ-scaled correction vector after normalization along with respective plots of the measured signal (Mₛ(v)), the PSS 1200 k, and PSS 250 k. As illustrated in FIG. 15, the two peaks of the deconvoluted vector (S*(v)) were relatively sharper or more accurate than the measured signal (Mₛ(v)). Additionally, the gap or valley between the two peaks of the deconvoluted vector (S*(v)) were more closely resolved and better represent the mixture of the PSS 1200 k and PSS 250 k analytes as compared to the measured signal (Mₛ(v)).

As further illustrated in FIG. 15, the deconvoluted vector (S*(v)) also exhibited a “dip” at about 21 mL. Without being bound by theory, it is believed that the artifact (“dip”) may arise because in at least one of the solutions to the inverse problem, a straight line projection from the new or “pro-convolved” signal (H(v)) to the measured signal (Mₛ(v)) may not pass through the true weight signal (S(v)). It should be appreciated, however, that the straight line may pass into the vicinity or may be proximal to the ground truth (S(v)). As such, the deconvoluted vector (S*(v)) may be modified to correct for this artifact. For example, an iterative approach may be implemented to determine a vector that may satisfy all constraints while concurrently satisfying Equation (2). In this particular instance, one having ordinary skill in the art may understand, through chromatography, that each of the polystyrene weight fraction components (along with their respective molecular weight) must in fact be positive, and with this constraint or parameter (e.g., user-defined input), the C2D process may be constrained to select solutions bounded by these properties. Furthermore, it should be well-understood that the summed slice-areas of the observed broadened distributions may not change from the observed distribution to the solution space, thus the C2D may be further constrained based on this understanding of the chromatographic system. Note that the C2D step/process may be used as a “polishing step” to optimize a solution produced by one or more additional algorithms shown herein, but is not bounded-by, nor limited to the examples shown herein.

The error signal (E(v)) can be thought of as a vector that maps from the pro-convolved signal (H(v)) to or in a direction that will pass close to the proximity of the ground truth signal (S*(v)). Another useful approach to refine estimates further is to generate a second error signal (E2(v)) that is orthogonal to the initial error signal E(v). The method by which such an orthogonal vector can be found is by creating an arbitrary intermediate vector J(v) that is not parallel to E(v), for example, by adding a random vector to the error signal (E(v)) and projecting E(v) onto J(v) using a standard formula such as E2(v)=J(v)−(J(v)·E(v))E(V). The second error vector E2(v) can be used to find further corrections. In this way, a set of error vectors may be produced, that expands to form an orthonormal basis of preferential directions in which corrections that contribute meaningfully to deconvoluting the signal may be found. The basis may also be expanded by using any other deconvolution techniques to create deconvolution candidate or deconvolution candidate signals.

### Shift Process

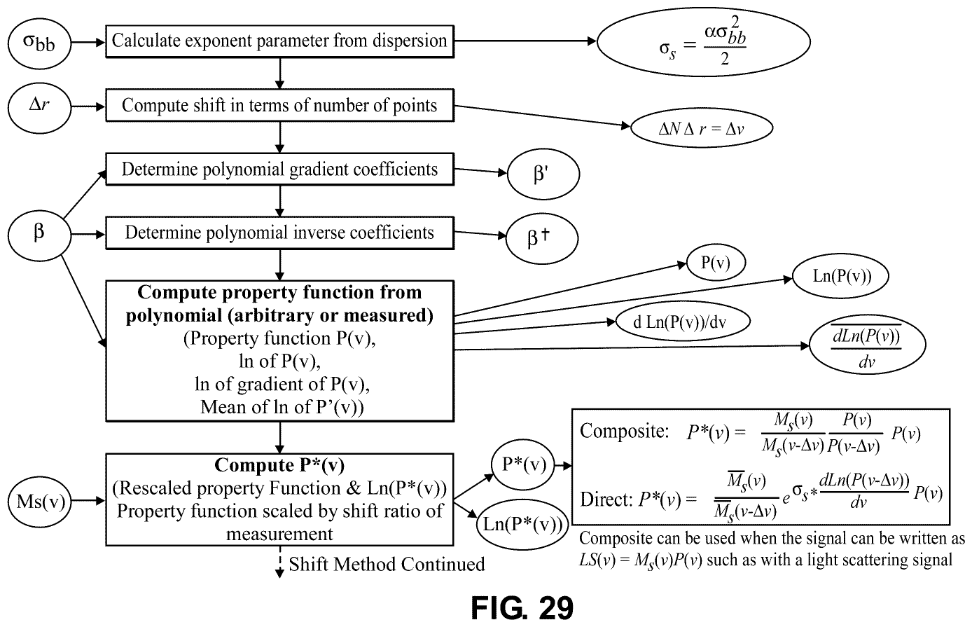

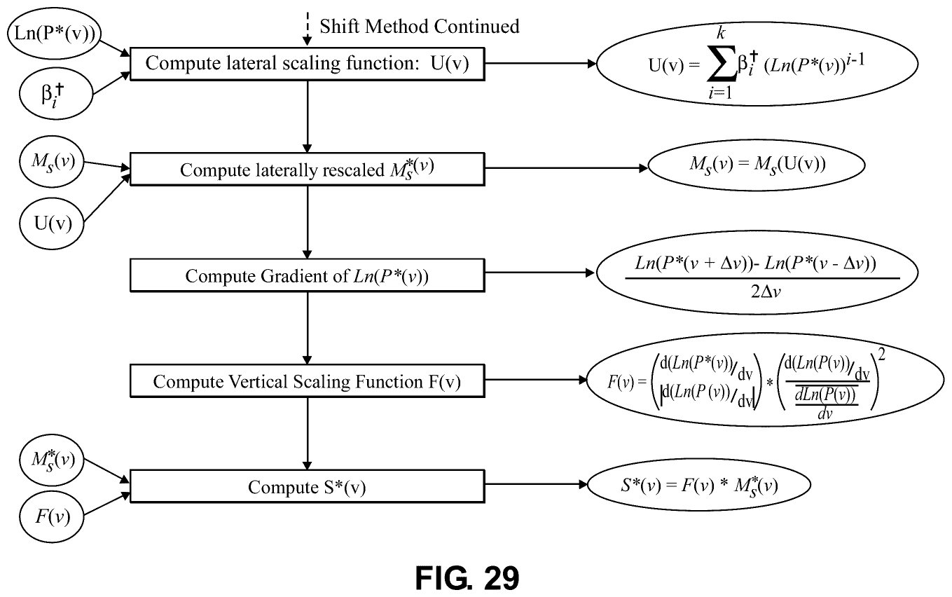

FIG. 29 illustrates an exemplary workflow for the shift process or method, according to one or more embodiments. The shift process may include a method for removing the effects of convolution from one or more measured signals (Mₛ(v)), such as signals from a detector of a packed bed chromatography system. Historical methods (Yau et al.; hereafter, “Yau”) have addressed correcting a molecular weight distribution through a calibration slope change. Yau, W. W., Giddings, J. C., & Myers, M. N. (1977). Calibration of gel permeation chromatography: molecular-weight distributions of polystyrene. Journal of Applied Polymer Science, 21(7), 1911-1920. By assuming a functional form for the dispersion (e.g., Gaussian), the slope change yields a factor with which to multiply moments of the molecular weight distribution, thereby yielding the correct averages for different moments. See, Yau. However, there may be one such factor for each of the moments of the underlying chromatogram. The goal of the shift method disclosed herein may be to remove the effects of convolution from a raw signal—such as column dispersion that affects a raw chromatogram (Mₛ(v)) in retention volume space—through the use of a transformation involving an arbitrary intermediate function (P(v)) that may be termed the separation function. The de-convolved signal may then be used in analysis to compute quantities of interest directly, using the un-corrected, original separation function. Such scenarios may be or include, but are not limited to, situations where the separation function may represent any one or more physical separation processes including, but not limited to, quantities such as molecular weight, radius of gyration, hydrodynamic radius, or charge, or the like, or any combination thereof; and thus, may have a relatively broader range of applicability than conventional treatments of dispersion and deconvolution in chromatography.

A measured signal (Mₛ(v)) may be related to the arbitrary separation function P(v) by the following general expression represented by Equation 13:

$${P}^{*} ( v ) = \frac{{\int }_{- ∞}^{+ ∞} G ( v - y ) S ( y ) P ( y ) d y}{{M}_{s} ( v )} = \frac{{\int }_{- ∞}^{+ ∞} G ( v - y ) S ( y ) P ( y ) d y}{{\int }_{- ∞}^{+ ∞} G ( v - y ) S ( y ) d y} \qquad ( 13 )$$

where S(v) may be the underlying quantity of interest as it would be without dispersion, where G(v−y) may be the convolution kernel representing the dispersion process, and where P*(v) may be a modified form of the separation function, P(v). The measured signal (Mₛ(v)) may be related to the unconvoluted signal S(v) by the denominator as represented in Equation 14:

$${M}_{s} ( v ) = {\int }_{- ∞}^{+ ∞} G ( v - y ) S ( y ) dy \qquad ( 14 )$$

where γ may be a dummy variable of integration dimensionally equivalent to retention volume space, and where the quantity Mₛ(v) may be normalized. Overall, P*(v) may be the local average of the unknown quantity S(v) after dispersion weighted by an arbitrary separation function P(v).

The method may assume a vertical (F(v)) and horizontal scaling (U(v)) for Mₛ(v) exists to yield an approximation S*(v) such that:

$$S ( v ) \approx {S}^{*} ( v ) = F ( v ) * {M}_{s} ( U ( v ) ) \qquad ( 15 )$$

which acts to compress the horizontal axis, at the same time as scaling the amplitude for the measured quantity (Mₛ(v)) in such a way that the unconvoluted ground truth signal S(v) may be closely approximated, whether it is a chromatogram or some other signal.

In at least one implementation, the quantities F(v) and U(v) may be determined from P(v) and P*(v), where one or more of the following constraints for the behavior of P*(v), F(v), and U(v) may be utilized.
1. P*(v) may be monotonic in v.
2. P*(v) may be continuous.
3. The curve S*(v) may remain positive for all v, F(v), U(v), P(v), and P*(v).
4. The area under the curve of S*(v) may be conserved and may be equal to the area under Mₛ(v) for any F(v) or U(v), that we apply.

In at least one implementation, the method may include defining a relatively small displacement (ΔN*Δr) along the coordinate axis v. In chromatography, v may be the retention volume, Δr may be the slice increment (e.g., sampling resolution), and ΔN may be the size of the shift in units of number of slices. ΔNΔr may be known as the “shift volume” and analogous quantities may be defined in any situation to which this method applies.

In at least one implementation, an approximation to P*(v) may be constructed using information from the measured quantity displaced by the shift volume (Mₛ(v−ΔNΔr)), the separation function P(v), and the gradient of the logarithm of the separation function

$$\frac{d ln ( P ( v ) )}{d v} ,$$

which may be evaluated at positions v or v−ΔNΔr along the retention volume axis.

For example, in at least one implementation P*(v) may be computed or determined by shifting the measured quantity Mₛ(v) by an arbitrary shift volume ΔNΔr that may be related to a slope of the logarithm of the separation function (P(v)).

$${P}^{*} ( v ) = \frac{{\int }_{v - 4 Δ r}^{v + 4 Δ r} {M}_{s} ( y ) dy}{{\int }_{v - 4 Δ r}^{v + 4 Δ r} {M}_{s} ( y - Δ N Δ r ) dy} * {e}^{\frac{a {σ}^{2}}{2} \times \frac{d ln ( P ( v - Δ N Δ r ) )}{d v}} P ( v ) \qquad 16$$

Where σ may be the dispersion estimate, and α may be a dimensionless parameter representing the fraction of dispersion to remove where 0≤α≤1. In general, the modified separation function P*(v) may be constructed by any appropriate method involving the separation function P(v).

In at least one implementation, P*(v) may be evaluated by assuming a functional form for the separation function (P(v)), which may include, but is not limited to, a polynomial expression of order k−1. This expression may be displaced by a small shift (ΔNΔr) along the retention volume axis, as expressed in Equation 17:

$$P ( v - Δ N Δ r ) = 1 {0}^{{\sum }_{i = 1}^{k} {{B}_{i} ( v - Δ N Δ r )}^{i - 1}} \qquad 17$$

where ΔN may be in units of retention volume slices and Bᵢ may be a set of polynomial coefficients that may be selected subject to one or more constraints disclosed herein. In this case, the parameters (Bᵢ) may be entirely arbitrary, or they may be derived from an experimental calibration procedure, such as using known standards to characterize the molecular weight separation behavior of a column, or some other quantity related to a packed bed separation process, or any set of rules that are reasonable. ΔN may be a constant, in which case the function P(v−ΔNΔr) may be shifted along the v-axis, or ΔN may be a function of v, in which case ΔN(v) may represent a localized stretch/compression of the separation function (P(v−ΔN(v))). In the latter case, ΔN(v) may be continuous and monotonic so the order of values in the stretched or compressed separation function (P(v−ΔN(v))) may be conserved.

The derivative of the logarithm of P(v−ΔNΔr) may be determined or computed, which may be shifted by an amount ΔNΔr along the retention volume axis.

$$\frac{d Ln ( P ( v - Δ N Δ r ) )}{d v} = ln ( 10 ) * {\sum }_{i = 1}^{k} ( i - 1 ) * {{B}_{i} ( v - Δ N Δ r )}^{i - 2} \qquad 18$$

The new function P*(v) may be evaluated for any value ΔN, or in more complex situation a function ΔN(v) that may be utilized as an input.

$${P}^{*} ( v ) = \frac{{\int }_{v - 4 Δ r}^{v + 4 Δ r} {M}_{s} ( y ) dy}{{\int }_{v - 4 Δ r}^{v + 4 Δ r} {M}_{s} ( y - Δ N Δ r ) dy} * {e}^{\frac{1}{2} a {σ}^{2} l n ( 10 ) {\sum }_{i = 1}^{k} ( i - 1 ) {{B}_{i} ( v - Δ N Δ r )}^{- 2 + i}} {10}^{{\sum }_{i = 1}^{k} {v}^{i - 1} {B}_{i}} \qquad 19$$

In at least one implementation, ln(P*(v) may be determined numerically, and from this determination a numerical gradient

$$\frac{d ln ( {P}^{*} ( v - Δ N Δ r ) )}{d v}$$

for any given value of ΔN or function ΔN(v).

In at least one implementation, the vertical stretching function F(v) may be given by:

$$\frac{d ln [ {P}^{*} ( v ) ]}{d v} = \frac{ln [ {P}^{*} ( v + Δ r ) ] - ln [ {P}^{*} ( v - Δ r ) ]}{2 Δ r ln [ 10 ]} \qquad 20$$

$$\frac{d ln [ P ( v ) ]}{d v} = \frac{ln [ P ( v + Δ r ) ] - ln [ P ( v - Δ r ) ]}{2 Δ r ln [ 10 ]}$$

$$F ( v ) = \frac{d ln [ {P}^{*} ( v ) ]}{d v} / \frac{d ln [ P ( v ) ]}{d v}$$

where Δr may be the resolution of the sampling of the retention volume.

In at least one implementation, a new set of polynomial coefficients

$${B}_{i}^{†}$$

may be found that yield the value of v associated with a particular value of ln(P). These

$${B}_{i}^{†}$$

may form a polynomial that may be inverse of the polynomial of coefficients Bᵢ from Equation 17:

$${v}^{†} ( ln ( P ) ) = {\sum }_{i = 1}^{k} {B}_{i}^{†} {ln ( P )}^{i - 1} \qquad 21$$

$${v}^{†} ( ln ( P ( v ) ) ) = v$$

$$ln ( P ( {v}^{†} ( ln ( P ) ) ) ) = ln ( P )$$

The coefficients

$${B}_{i}^{†}$$

may be determined by fitting a polynomial regression of v plotted against values of ln(P(v))/ln(10).

In at least one implementation, a function U(v) may be determined by applying the inverse polynomial coefficients

$${B}_{i}^{†}$$

to the value of ln(P*(v)) rather than ln(P(v))

$$U ( v ) = {v}^{†} ( ln ( {P}^{*} ( v ) ) ) = {\sum }_{i = 1}^{k} {B}_{i}^{†} {ln ( {P}^{*} ( v ) )}^{i - 1} \qquad 22$$

In at least one implementation, F(v) and U(v) to Mₛ(v) may be applied to determine or compute a new quantity S*(v) that may correspond to a deconvolved chromatogram.

$${S}^{*} ( v ) = F ( v ) * {M}_{s} ( U ( v ) ) \qquad 23$$

$${S}^{*} ( v ) = \frac{d ln [ {P}^{*} ( v ) ]}{dv} * {M}_{s} ( {v}^{†} ( ln ( {P}^{*} ( v ) ) ) )$$

The function S*(v) may then be normalized to ensure its area matches the area of the original measured function Mₛ(v).

For example, a ground truth function (S(v)) given by the sum of two Gaussian distributions with widths σ₁ and σ₂, and mean positions μ₁ and μ₂ may be generated according to the following:

$$S ( v ) = \frac{{e}^{- \frac{{( v - {μ}_{1} )}^{2}}{2 {σ}_{1}^{2}}}}{2 \sqrt{2 π} {σ}_{1}} + \frac{{e}^{- \frac{{( v - {μ}_{2} )}^{2}}{2 {σ}_{2}^{2}}}}{2 \sqrt{2 π} {σ}_{2}} \qquad 24$$

S(v) may be convolved with a Gaussian having width σ_{b} to generate a simulation of Mₛ(v).

$${M}_{sim} ( v ) = {\int }_{- ∞}^{v} \frac{{e}^{- \frac{{( v - y )}^{2}}{2 {σ}_{b}^{2}}}}{\sqrt{2 π} {σ}_{b}} ( \frac{{e}^{- \frac{{( y - {μ}_{1} )}^{2}}{2 {σ}_{1}^{2}}}}{2 \sqrt{2 π} {σ}_{1}} + \frac{{e}^{- \frac{{( y - {μ}_{2} )}^{2}}{2 {σ}_{2}^{2}}}}{2 \sqrt{2 π} {σ}_{2}} ) dy \qquad ( 25 )$$

Given a particular set of separation function coefficients Bᵢ={9,−1}, P(v) and P*(v), and inverse coefficients

$${B}_{i}^{†} = \{ 9 , - 1 \}$$

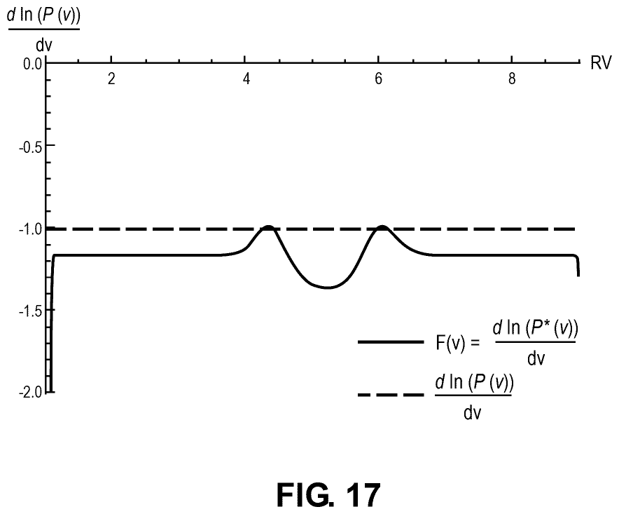

may be determined. In one implementation, the following input values may be selected: μ₁=5.5, σ₁=0.2, μ₂=6.0, 02=0.4, σ_{b}=0.2, ΔR=0.01, and ΔN=7.5. This may yield P(v) and P*(v), as illustrated in FIG. 16, and with the associated gradient functions, as illustrated in FIG. 17.

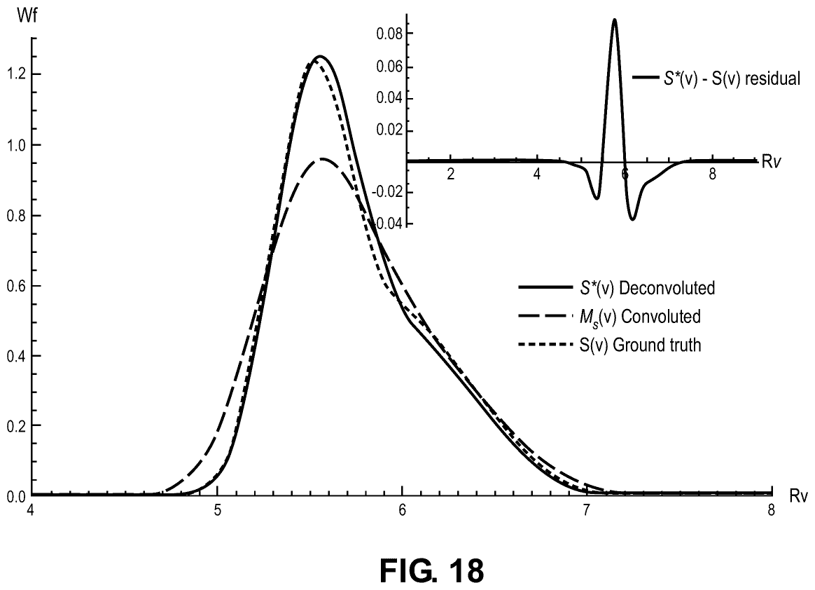

These P(v) and P*(v), and their gradients may be deployed, as previously described, to yield a deconvoluted function S*(v) with the inset residual between the deconvoluted function S*(v) and the ground truth (S(v)), as illustrated in FIG. 18.

In another implementation, P*(v) may be computed or determined using a method inspired by the fact that a light scattering signal (LS(v)) measured after chromatography may include a measured signal multiplied by the separation curve. The light scatting signal LS(v) may be referred to herein as a composite signal. For example, a refractive index signal measures the concentration of a sample that may be multiplied by the calibration function to yield an estimate for light scattering according to Equation 26.

$$LS ( v ) = {M}_{s} ( v ) * P ( v ) \qquad 26$$

Such a composite signal may be measured directly using a light scattering system or in an arbitrary scenario, that may not involve scattering light from molecules, a composite signal may be constructed from any measured signal multiplied by a completely arbitrary separation function. The combined composite signal (CS) may be shifted by a small displacement and divided by the original separation function P(v) to yield a shifted measured signal:

$${M}_{shift} ( v - Δ N Δ r ) = \frac{CS ( v - Δ N Δ r )}{P ( v )}$$

The original unshifted composite signal (Cs(v)) may then be divided by a shifted measured signal (M_{shift}(v)) to yield a corrected separation curve for the composite signal

$${P}_{CS}^{*} ( v ) .$$

$${P}_{CS}^{*} ( v ) = \frac{CS ( v )}{{M}_{shift} ( v - Δ N Δ r )} = \frac{{M}_{s} ( v ) * P ( v )}{( CS ( v - Δ N Δ r ) / P ( v ) )} = \frac{{M}_{s} ( v ) * P ( v ) * P ( v )}{( {M}_{s} ( v - Δ N Δ r ) * P ( v - Δ N Δ r ) )}$$

$${P}_{CS}^{*} ( v ) = \frac{{M}_{s} ( v )}{{M}_{s} ( v - Δ N Δ r )} * \frac{P ( v )}{P ( v - Δ N Δ r )} * P ( v )$$

In at least one implementation the separation function may be represented by a polynomial function of order k−1 to yield.

$${P}_{CS}^{*} ( v ) = \frac{{M}_{s} ( v )}{{M}_{s} ( v - Δ N Δ r )} * \frac{1 {0}^{{\sum }_{i = 1}^{k} {{B}_{i} ( v )}^{i - 1}}}{1 {0}^{{\sum }_{i = 1}^{k} {{B}_{i} ( v - Δ N Δ r )}^{i - 1}}} * 1 {0}^{{\sum }_{i = 1}^{k} {{B}_{i} ( v )}^{i - 1}}$$

$${P}_{CS}^{*} ( v ) = \frac{{M}_{s} ( v )}{{M}_{s} ( v - Δ N Δ r )} * {e}^{ln ( 10 ) {\sum }_{i = 1}^{k} {B}_{i} ( {v}^{i - 1} - {( v - Δ N Δ r )}^{i - 1} )} * {10}^{{\sum }_{i = 1}^{k} {{B}_{i} ( v )}^{i - 1}}$$

$${P}_{CS}^{*} ( v ) = \frac{{M}_{s} ( v )}{{M}_{s} ( v - Δ N Δ r )} * {e}^{ln ( 10 ) Δ N Δ r \frac{d ln ( P ( v ) )}{dv}} * {10}^{{\sum }_{i = 1}^{k} {{B}_{i} ( v )}^{i - 1}}$$

which may be close to the definition of P*(v) given in Equation 16 with the identity:

$$Δ N Δ r = \frac{1}{2} α {σ}^{2}$$

Giving a method for estimating the initial shift from the measured dispersion that may render the two methods equivalent. For example, a constructed light scattering function may be shifted and/or divided, as previously discussed, to yield a new composite modified separation function

$${P}_{CS}^{*} ( v )$$

that may be very close to the previous example

$${P}^{*} ( v ) \cdot {P}_{CS}^{*} ( v )$$

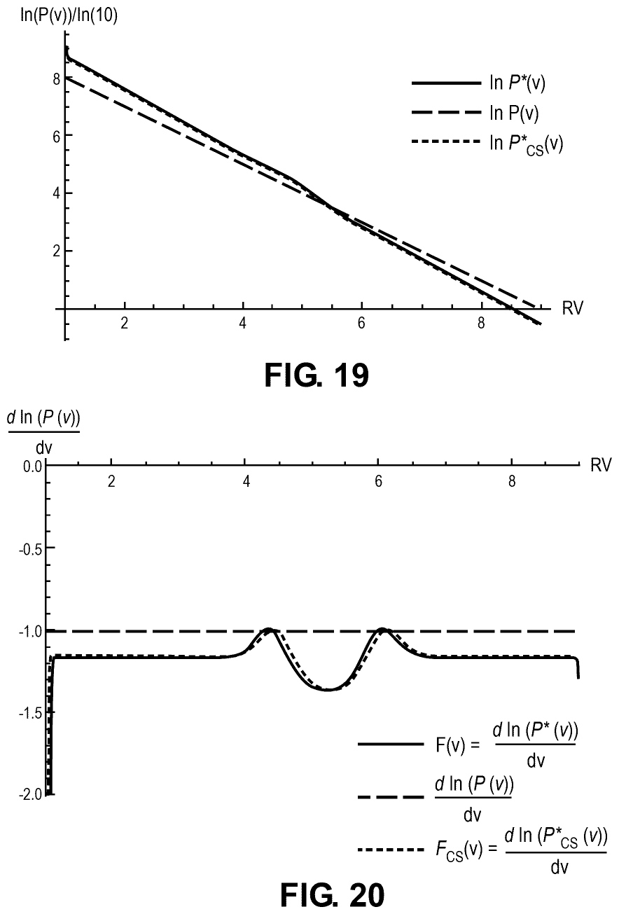

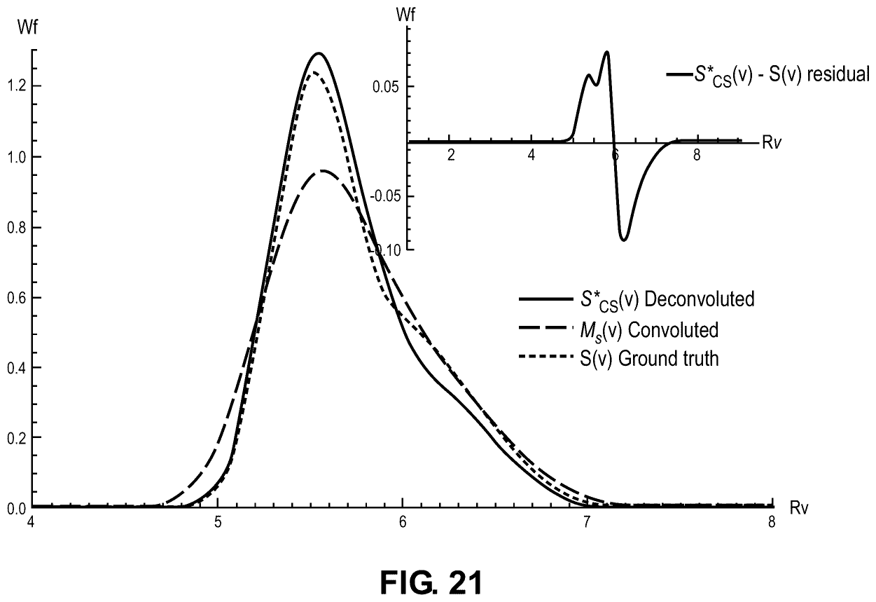

may be used as previously described to deconvolute the measured signal, as represented in FIGS. 19, 20, and 21.

### Moment Matching Process

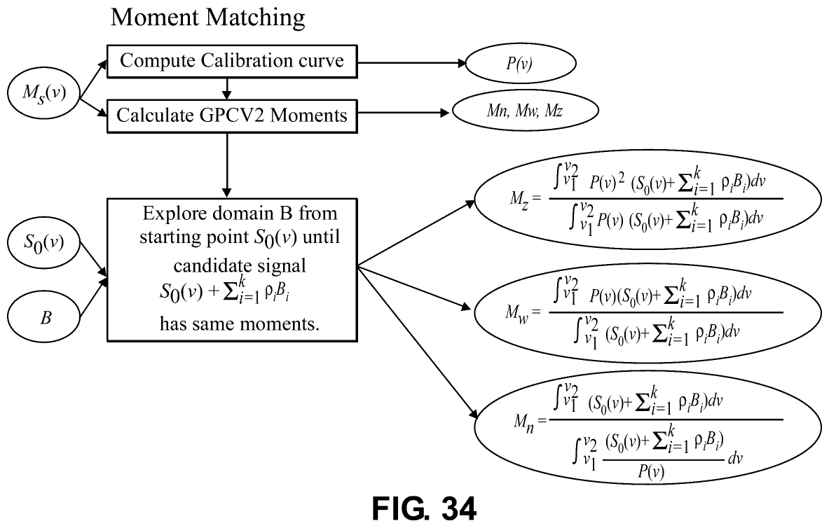

In at least one implementation, the deconvolution process may include the matching process. FIG. 34 illustrates an exemplary workflow for the moment matching process, according to one or more embodiments. The matching process may include operating or using linear combinations of a first difference vector (E1(v)) and a second difference vector (E2(v)) or a plurality of error vectors. For example, the method may include adding and/or subtracting linear combinations of E1(v) and E2(v) to adjust or modify the measured signal (Mₛ(v)). The measured signal (Mₛ(v)) may be adjusted or modified until different moments of the reconstructed signal match moments of an underlying distribution that could be directly determined by a range of experimental means.

For example, a measured signal (Mₛ(v)) can be processed using the Convolve-to Deconvolve process to determine two errors E1(v) and E2(v) which are orthogonal. If the measured signal corresponded to a weight fraction, then combinations of E1(v) and E2(v) can be added or removed from the measured signal (Mₛ(v)) until the weight average molecular weight (M_{w}), a number average molecular weight (Mₙ), and/or a Z average or size average molecular weight (M_{z}) associated or related to a distribution matches or substantially matches the (M_{w}), (Mₙ), and/or (M_{z}) determined from the Hamielec or Yau (e.g., GPCV2) methods. The modification of the measured signal (Mₛ(v)) may be iterative, stochastic and/or arbitrary.

### Direct EMG Fitting Process

In at least one implementation, the deconvolution process may include the direct exponentially modified gaussian (EMG) fitting process. The direct EMG fitting process may include fitting a measured curve with an EMG function. The direct EMG fitting process may also include determining a new parameter for an EMG with the dispersion parameter (σ_{b}) and a width parameter (σ_{w}). For example, determining the new parameter for the EMG may include subtracting the dispersion parameter (σ_{b}) and recalculating a new EMG with a different width parameter (σ_{w}).

In another implementation, the direct EMG fitting process may include determining a decomposition of the measured signal with a combination of a known distribution function and an EMG function. The known function may be or include, but is not limited to, a Poisson function, a Log Normal function, or any other suitable function known in the art.

### Iterative Deconvolution Processes

The amount of dispersion on a column or packed bed process may be estimated by analyzing a monodisperse sample of known low dispersity, such as BHT. In addition, numerous novel methods for blind deconvolution of a measured signal (Mₛ(v)) may yield initial estimates of a deconvolved ground truth (S*(v)).

An iterative process may be followed in which the known dispersion kernel (G(v, σ_{b})) may be convolved with the estimated ground truth S*(v) to produce or determine an estimate, R(v), for the measured signal (Mₛ(v)) that would arise on a given column if the ground-truth estimate (S*(v)) were correct. From the error (E(v)) or errors between the actual measured signal (Mₛ(v)) and the re-convolved estimate (R(v)) or estimates an improvement to the estimate of the ground truth (S*(v)) may be made or determined. It must be appreciated that this method does not or may not require prior knowledge of the ground truth.

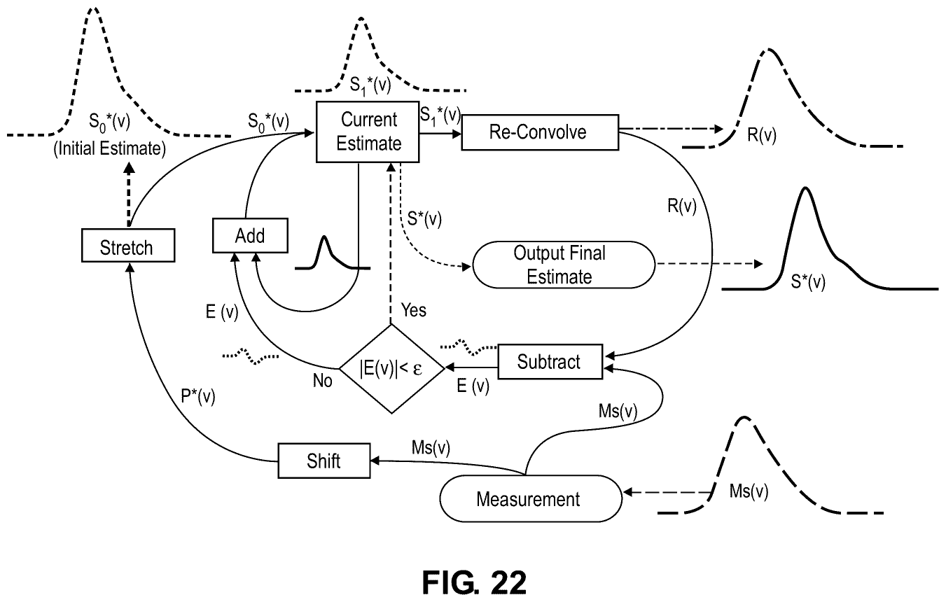

FIG. 22 illustrates an exemplary workflow of the iterative process, according to one or more embodiments disclosed. The iterative process may provide an improved determination or estimate of the ground-truth (S*(v)) as compared to a single step of deconvolution, and may correct for processing and measurement artifacts, such as ringing and dips below the horizontal axis for a measurement that represents only positive quantities. Any of the methods described above may generate an input function to the iterative procedure.

For a validation of an iterative example, a known ground truth S(v), may be convolved to create a simulated measurement Mₛ(v), which may then be put through the shift algorithm to create or provide an initial determination or guess for a deconvolved ground truth

$$( {S}_{c {s}_{0}}^{*} ( v ) ) .$$

Following the shift algorithm, the initial determination or guess

$${S}_{c {s}_{0}}^{*} ( v )$$

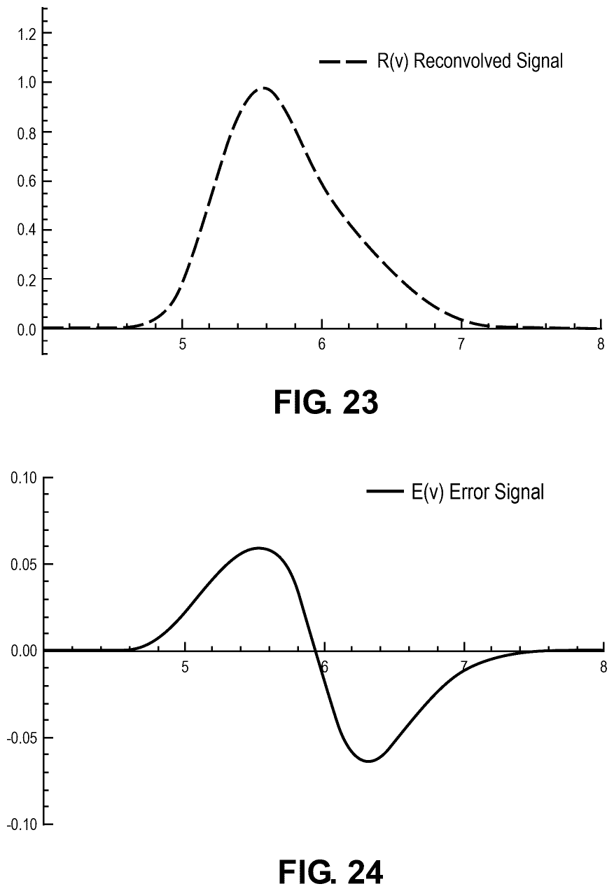

may be re-convolved with a Gaussian kernel to yield an interim function R(v) according to the following and represented in FIG. 23:

$$R ( v ) = {\int }_{v - 10 {σ}_{b}}^{v + 10 {σ}_{b}} G ( v - y ) {S}_{c {s}_{0}}^{*} ( y ) dy$$

The R(v) interim function may be subtracted from the original measured signal Mₛ(v) to yield an error signal according to the following and as represented in FIG. 24:

$$E ( v ) = R ( v ) - {M}_{s} ( v )$$

The error signal may be subtracted from the Initial estimate to yield an improved estimate according to the following:

$${S}_{1}^{*} ( v ) = {S}_{c {s}_{0}}^{*} ( v ) - E ( v )$$

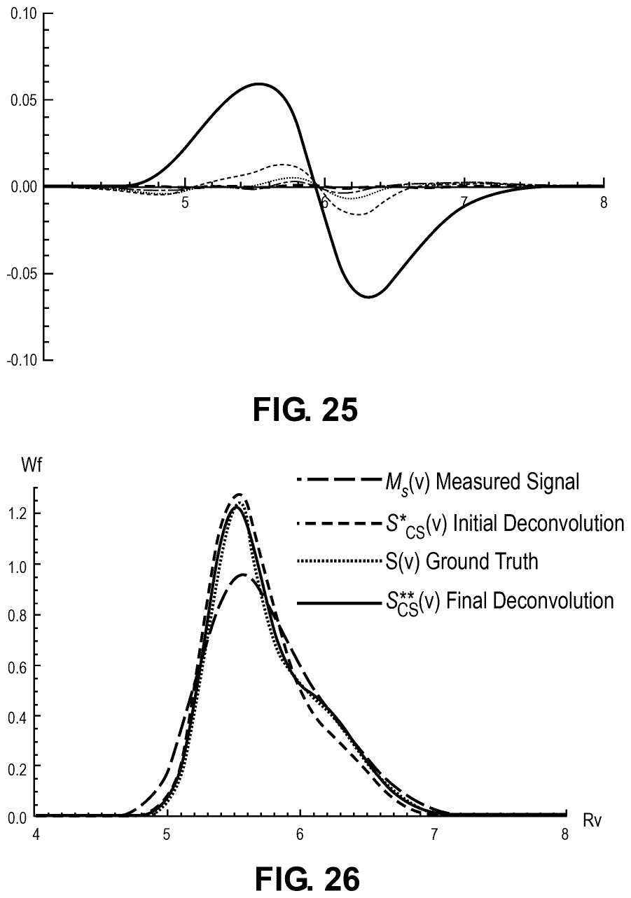

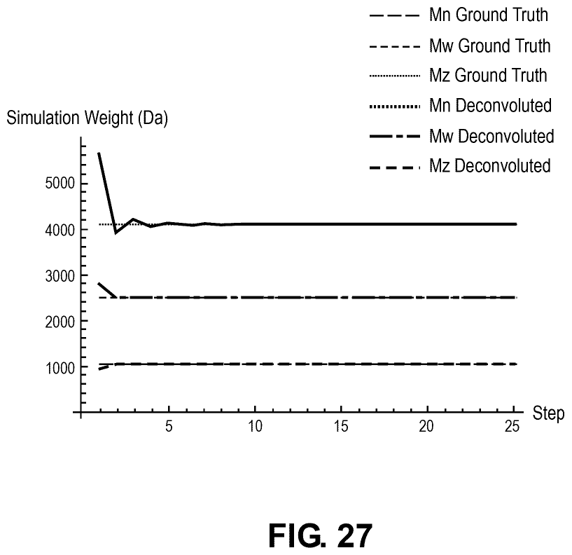

The improved estimate may be re-convolved by repeating one or more of the foregoing steps. The process may be repeated one or more instances. For example, the process may be repeated until the magnitude of the error signal is reduced below an arbitrary predefined threshold (ϵ), or when computed values attain a known experimental precision. FIG. 25 illustrates a plot of the repeated iterations. After sufficient iterations the estimate may match the ground truth in a blind deconvolution. In an exemplary implementation, the ground truth may be unknown and may not be used in this algorithm, but as shown in FIG. 26 for validation, is not necessary to produce or determine a solution. For practical validation, weight-fraction distributions may be compared to longer bed length columns which would increase the separation to dispersive elements in the chromatographic system. In one implementation, illustrated in FIG. 27, molecular weights may be computed and plotted as the iteration proceeds.

### Determining a Sufficient Algorithm

It should be noted that in many cases, if the goal is to separate distinct analytes, the deconvolution process may not have to remove all of the ECE and dispersive effects of the system (e.g., chromatographic system) or the detector thereof. The amount of ECE and dispersive effects may be subtracted to obtain baseline-separation or near-baseline separation for better quantitation of areas, for instance. These areas may be determined by the summation of the responses after the partial deconvolution process or could aid in fitting of the components to functions such as known distributions, such as EMG functions, Poisson distributions. Since response signals may contain white noise, which may be accentuated by the deconvolution processes, the ability to select which, as well as a percentage, of the individual band broadening effects to be removed allows a user (e.g., the chromatographer) to balance resolution increases (for example increasing a single column system resolution to that of an equivalent 2, 3, or 4 column system). Elimination of part of the band-broadening, for example, may be used effectively to correct high throughput data. In these implementations, the results (screening or analytical) may be validated by performing the equivalent runs on the longer packed bed system. In such cases, both time, solvent, and the amount of analyte may be well-conserved, and the most promising samples may be validated using the traditional, more resource-intensive approaches.

It should be understood that combining deconvolution solutions for multi-detector analysis may have several advantages, for example, concentration and light scattering solutions may be connected in a simultaneous deconvolution using expert knowledge of their single weight-fraction distribution and log molecular weight monotonic assumptions that may dictate the calibration curve. Advantages of the proposed deconvolution may provide or produce a superior constrained solution, especially with samples containing multiple inversions of the differential weight fraction slope, over traditional techniques. Furthermore, the P*(v) may not have to be linear with respect to the separation power of the column.

### Applying Additional Algorithms

In at least one implementation, the method may include applying one or more additional algorithms. For example, the additional algorithms may be or include any algorithms of deconvolution or decomposition known in the art, which may include direct or indirect chromatographic shape models or mathematical chromatography simulations, or generalized algorithms that may resolve extra-column effects, such as band-broadening, including those based on SEC, Slalom, hydrodynamic chromatography, as well as HPLC normal phase and gradient systems, especially those coupled with switching values, filtration sampling, or inherently low-resolution systems. In addition to the foregoing, charge-based separation effects may be modeled or extracted as the outputs of these systems, including predicted gradient deliveries as well as the decomposition or deconvolution of chromatographic shapes, including those that may be related to HPLC or GC separations, especially those on a packed-bed system or those under a laminar flow regime.

### Applying User/Consumer Input Algorithms

In at least one implementation, the method may include user-input algorithms to allow the separation of the algorithms from the main process loop or workflow for investigational and in-use studies.

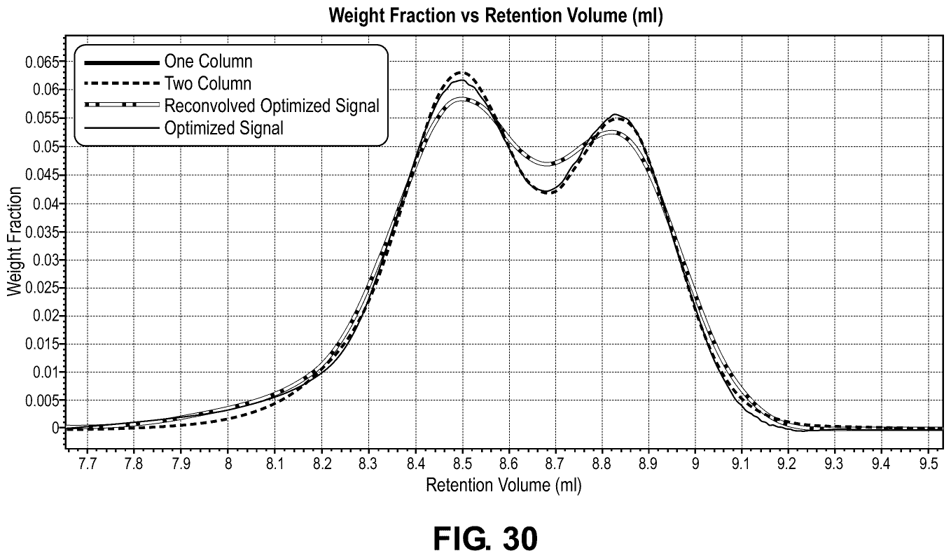

FIG. 30 illustrates a plot of output signals for a mixture containing two similar monodispersed polymers samples. The detector (i.e., a refractive index detector) utilized was the same; however, the separation media in a first trace was with a single column and a second trace was with two similar columns in series. As illustrated in FIG. 30, the two columns in series exhibited a relatively higher resolution than the single column, as indicated by the deeper valley between the peaks. FIG. 30 further depicts an optimized, error-minimized, or dispersion corrected signal generated or prepared according to the systems and methods disclosed herein. The dispersion corrected signal was generated from the output of the single column. As illustrated in FIG. 30, removing the dispersion effect of the detector and/or the single column thereof yielded the dispersion corrected signal, which surprisingly and unexpectedly demonstrates the resolution or substantially the same resolution obtained with the two-columns in series. It was further surprisingly and unexpectedly discovered that the optimized or dispersion corrected signal reconvolved to recreate the same output as the original single output from the single column. It should be appreciated that the deconvolution was blind; meaning that no information or output from the two-column system/setup was used to generate the dispersion corrected signal. Said in another way, the output from the two-columns in series is presented merely for comparison.

### Exemplary Method

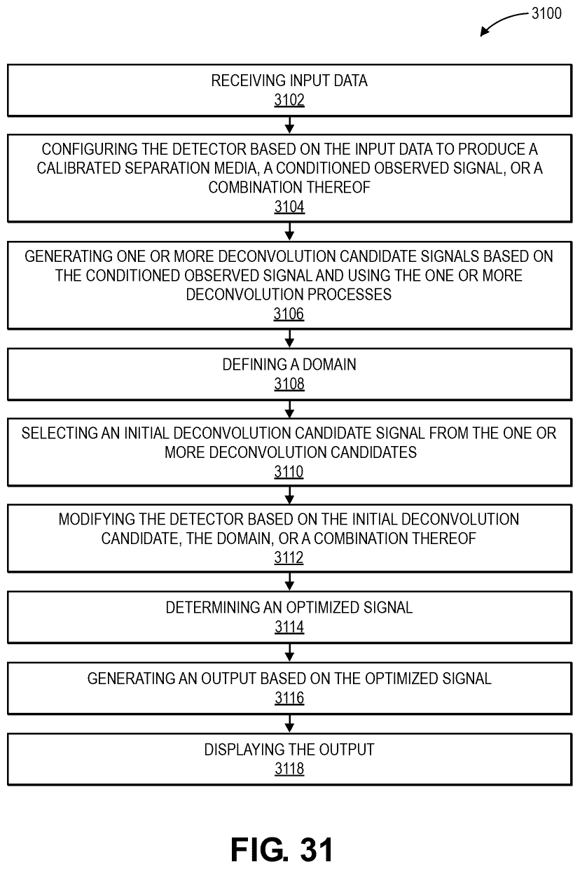

FIG. 31 illustrates a flowchart of an exemplary method 3100, according to one or more embodiments. The method 3100 may also be for determining or obtaining an optimized, error-minimized, or dispersion corrected signal from a system and/or a detector thereof. The method 3100 may also be for modifying a system and/or a detector thereof including a separation media. The method 3100 may also be for modifying a system and/or a detector thereof including a calibrated separation media. The method 3100 may also be for obtaining an error-minimized signal or a dispersion corrected signal of an unknown sample with a system and/or a detector thereof including a separation media (e.g., calibrated separation media). The method 3100 may also be for generating a training set for a machine-learning (ML) or artificial intelligence (AI) model. The method 3100 may also be for enhancing predictive capabilities for high throughput screening, reducing chromatographic time and solvent, by reducing the number of columns necessary for analysis, increasing accuracy of quantitation of analytes, enhancing prediction of physical properties of macromolecules, such as rheological predictions from molecular weight. While an illustrative order of the method 3100 is provided, one or more portions of the method 3100 may be performed in a different order, simultaneously, repeated, and/or omitted. For example, one or more steps and/or one or more portions thereof (e.g., portions of the steps) of the method 3100 may be omitted, reorganized, repeated, or any combination thereof. At least a portion of the method 3100 may be performed using a computing system disclosed herein.

The method 3100 may include receiving input data, as at 3102. The input data may be received from a system, such as the system 100 of FIG. 1, and/or a component thereof, such the detector 102 and/or the computer 106. The input data may include one or more of an observed signal (M(v)) of an unknown sample, data or a signal of at least one known sample, raw data, one or more user-defined inputs, or a combination thereof. The observed signal (M(v)) of the unknown sample may include a chromatogram of the unknown sample. The chromatogram of the unknown sample may include one or more peaks. The chromatogram of the unknown sample may be generated using a separation media and the detector. The data of the at least one known sample may include one or more of a chromatogram of the at least one known sample using the separation media and the detector, a sampling resolution (Δν) for generating the chromatogram, or a combination thereof. The chromatogram of the at least one known sample may include one or more peaks. The data of the at least one known sample may further include a respective retention volume (vᵢ) for each of the one or more peaks. The respective chromatogram of the at least one known sample and the unknown sample may include a sequence of W numbers/values or plates. Each W number or plate may correspond to a retention volume (v) separated by the sampling resolution (Δν). The observed signal (M(v)) of the unknown sample may be a filtered signal (M_{f}(v)). The filtered signal (M_{f}(v)) may be produced by filtering the observed signal (M(v)) of the unknown sample using a filtering process and based on a signal-to-noise ratio (ξ) of the observed signal (M(v)). The filtering process may include a Fast Fourier Transform (FFT) bandpass process. The at least one known sample may be a monodispersed sample. The separation media may be an unknown separation media. For example, the separation media may be an uncalibrated separation media. In another example, the separation media may be a calibrated separation media. The one or more user-defined inputs may include, but are not limited to, one or more parameters/constraints, presets of the system or a component thereof (e.g., the detector), or a combination thereof.

In at least one implementation, the input data may also include, but is not limited to, one or more of a conditioned observed signal, a normalized conditioned observed signal, one or more distribution parameters of the separation media, a baseline from the one or more peaks of any of the chromatograms, such as the chromatogram of the at least one known sample, a peak shape model (e.g., asymmetric peak shape model) fitted to any one or more of the peaks of the foregoing chromatograms, a convolution kernel (K(σₖ, v)), a kernel width (σₖ), a signal-to-noise ratio (ξ) of the observed signal (M(v)) of the unknown sample, a baseline correction (θ+çv) of the chromatogram of the unknown sample based on the observed signal (M(v)), a region of interest (Lᵥ, Rᵥ) (ROI) of the chromatogram of the unknown sample, a left limit (Lᵥ) of the ROI, a right limit (Rᵥ) of the ROI, a respective area (A) of each peak of the one or more peaks of the chromatograms, or any combination thereof. The one or more distribution parameters of the separation media may include one or more of a mean retention time (μ), a dispersion parameter (σ_{BB}), a delay constant (τ), or a combination thereof. The convolution kernel (K(σₖ, v)) may be a function that describes how a system or detector spreads, blurs, distorts, or mixes an input signal when producing an observed output. For example, the convolution kernel (K(σₖ, v)) is the function that defines how a system/instrument transforms a true signal or ground truth into the measured, broadened, or blurred output. The convolution kernel (K(σₖ, v)) may encode the system's characteristic response.

The method 3100 may also include configuring the detector based on the input data to produce a calibrated separation media, a conditioned observed signal (Mₛ(v)), or a combination thereof, as at 3104. The conditioned observed signal may be a raw observed signal that has been processed or preprocessed with a set of operations (e.g., baseline correction, noise suppression, filtering, normalization, peak shape correction, artifact removal, etc.) that transform the raw observed signal into a form that is more stable and interpretable. The conditioned observed signal may be a normalized conditioned observed signal. Configuring the detector may be or include configuring deconvolution based on the input data to produce the conditioned observed signal (Mₛ(v)), the convolution kernel K(σ, v), a known area of an observed detector signal (M(v)), a separation function (P(v)), or a combination thereof. Configuring the detector or configuring deconvolution may include calibrating the separation media based on the input data to produce the calibrated separation media. The separation media may be calibrated based on the data or signal of the at least one known sample. Calibrating the separation media may include determining one or more distribution parameters of the detector and/or the separation media thereof based on the data of the at least one known sample. Determining the one or more distribution parameters may include removing a baseline from the one or more peaks of the chromatogram of the at least one known sample. Determining the one or more distribution parameters may also include fitting the one or more peaks with an asymmetric peak shape model. The asymmetric peak-shape model may include an Exponentially Modified Gaussian (EMG), an Asymmetric Generalized Normal, or the like, or any combination thereof. Determining the one or more distribution parameters may further include determining the one or more distribution parameters based on the asymmetric peak-shape model to calibrate the separation media. The one or more distribution parameters may include one or more of a mean retention time (μ), a dispersion parameter (σ_{BB}), a delay constant (τ), or a combination thereof. Calibrating the separation media may also include calibrating the separation media based on the one or more distribution parameters.

In at least one implementation, for example, when utilizing a moment conservation constraint or parameter, calibrating the separation media may include determining a property of the at least one known sample for the respective retention volume (vᵢ) for each peak of the one or more peaks. The property may include one or more of a molecular weight, polarity, charge interaction, size, molecular volume, affinity, molecular interactions, distribution coefficient, or any combination thereof. Calibrating the separation media may also include generating a plot based on the property of the at least one known sample and the respective retention volume (vᵢ). Calibrating the separation media may also include fitting a polynomial to the plot. Calibrating the separation media may also include calibrating the separation media based on the polynomial.

Configuring the detector or configuring deconvolution may also include generating the convolution kernel (K(σₖ, v)) based on the calibrated separation media, the input data, or a combination thereof. The convolution kernel (K(σₖ, v)) may be based on the one or more distribution parameters of the separation media. The convolution kernel (K(σₖ, v)) may be based on the dispersion parameter (σ_{BB}). Generating the convolution kernel (K(σₖ, v)) may include determining a kernel width (σₖ) based on the calibrated separation media. The kernel width (σₖ) may be based on one or more of the asymmetric peak-shape model, the one or more distribution parameters, the input data, or a combination thereof. The kernel width (σₖ) may be determined based on the dispersion parameter (σ_{BB}) of the asymmetric peak-shape model. The kernel width (σₖ) may be determined based on the asymmetric peak-shape model. The kernel width (σₖ) may be determined based on the one or more user-defined inputs of the input data. Generating the convolution kernel (K(σₖ, v)) may also include generating a Gaussian function (G(0, σₖ, v)) based on one or more of the kernel width (σₖ), the dispersion parameter (σ_{BB}), the input data, or a combination thereof. In an exemplary implementation, the convolution kernel or the Gaussian function is generated based on the kernel width. The Gaussian function (G(0, σₖ, v)) may be based on the kernel width (σₖ), the dispersion parameter (σ_{BB}), and/or the data of the at least one known sample. The Gaussian function (G(0, σₖ, v)) may be based on the kernel width (σₖ), the dispersion parameter (σ_{BB}), and/or the sampling resolution (Δν) of the at least one known sample. Generating the convolution kernel (K(νₖ, v)) may also include generating the convolution kernel (K(σₖ, v)) based on the Gaussian function (G(0, σₖ, v)). The convolution kernel (K(σₖ, v)) may be a symmetric Gaussian convolution kernel centered at about 0. In at least one implementation, configuring the detector or configuring deconvolution may also include receiving the observed signal (M(v)) of the unknown sample.

In at least one implementation, configuring the detector or configuring deconvolution may also include determining the signal-to-noise ratio (ξ) of the observed signal (M(v)) of the unknown sample. Determining the signal-to-noise ratio (ξ) may include determining a baseline correction (θ+çv) of the chromatogram of the unknown sample based on the observed signal (M(v)). Determining the signal-to-noise ratio (ξ) may also include generating a corrected chromatogram (M_{b}(v)) of the unknown sample based on the baseline correction (θ+çv). Determining the signal-to-noise ratio (ξ) may also include determining a region of interest (Lᵥ, Rᵥ) (ROI) of the chromatogram of the unknown sample or the corrected chromatogram of the unknown sample based on the input data. The region of interest (Lᵥ, Rᵥ) (ROI) may be based on the one or more user-defined inputs of the input data. The region of interest (Lᵥ, Rᵥ) may be the limits in retention of volume of the ROI, where Lᵥ is a left limit and Rᵥ is a right limit. Determining the signal-to-noise ratio (ξ) may also include determining a respective area (A) of each peak of the one or more peaks in the region of interest (Lᵥ, Rᵥ) (ROI) of the corrected chromatogram (M_{b}(v)) of the unknown sample. Determining the signal-to-noise ratio (ξ) may also include normalizing the chromatogram of the unknown sample or the corrected chromatogram (M_{b}(v)) of the unknown sample. The respective chromatograms may be normalized such that the area between the limits of the ROI is 1. Determining the signal-to-noise ratio (ξ) may also include determining the signal-to-noise ratio (ξ) based on the baseline correction (θ+çv) and the respective area (A) of each peak of the one or more peaks.

In at least one implementation, configuring the detector or configuring deconvolution may also include filtering the observed signal (M(v)) of the unknown sample to produce a filtered signal (M_{f}(v)) based on the signal-to-noise ratio (ξ), the input data, or a combination thereof. Filtering the data of the observed signal (M(v)) may include filtering the chromatogram of the unknown sample or the corrected chromatogram (M_{b}(v)) of the unknown sample using a filtering process and based on the signal-to-noise ratio (ξ). The filtering process may include a Fast Fourier Transform (FFT) bandpass process.

In at least one implementation, configuring the detector or configuring deconvolution may also include generating the conditioned observed signal (Mₛ(v)) based on the chromatogram of the unknown sample, the corrected chromatogram (M_{b}(v)) of the unknown sample, and/or the filtered signal (M_{f}(v)). Generating the conditioned observed signal (Mₛ(v)) may include determining a respective area of the one or more peaks of the chromatogram of the unknown sample, the corrected chromatogram of the unknown sample, or the filtered signal (M_{f}(v)). Generating the conditioned observed signal (Mₛ(v)) may also include generating the conditioned observed signal (Mₛ(v)) based on the respective area of the one or more peaks of the chromatogram of the unknown sample, the corrected chromatogram of the unknown sample, and/or the filtered signal (M_{f}(v)).

The method 3100 may also include generating one or more deconvolution candidate signals (S₀ᵢ(v)) based on the conditioned observed signal (Mₛ(v)) and using the one or more deconvolution processes, as at 3106. The conditioned observed signal may be normalized. The one or more deconvolution processes may be or include, but is not limited to, an FFT method, a convolve to deconvolve method, a shift composite method, a shift direct method, a matching method, a theoretical model, or the like, or any combination thereof. Generating the one or more deconvolution candidate signals (S₀ᵢ(v)) may include applying the one or more deconvolution processes to the conditioned observed signal (Mₛ(v)). For example, generating the one or more deconvolution candidate signals may include applying each of the one or more deconvolution processes to the conditioned observed signal to produce a respective deconvolution candidate signal of the one or more deconvolution candidate signals. Applying each deconvolution process of the one or more deconvolution processes produces a respective deconvolution candidate signal of the one or more deconvolution candidate signals.

The method 3100 may also include defining a domain (B), as at 3108. The domain (B) may be of the optimized signal, the system, the detector, or any combination thereof. The domain may be defined based on the conditioned observed signal (Mₛ(v)), the convolution kernel (K(σₖ, v)), the calibrated separation media, the input data, or a combination thereof. The conditioned observed signal may be normalized. The domain (B) may be or include a multidimensional domain (B) defined by an N-dimensional vector space. The N-dimensional vector space may include a plurality of correction vectors (Cₖ). The plurality of correction vectors may be based on a set of N basis vectors (Bᵢ). The plurality of correction vectors may be represented by the following Equation:

$${\underline{C}}_{k} = {\sum }_{i = 1}^{N} {ρ}_{k i} {B}_{i}$$

where: ρₖᵢ is a set of parameters, Bᵢ is the set of N basis vectors, Cₖ is a sum of the set of basis vectors weighted by the set of parameters. A k^{th} correction vector

$$( {\underline{C}}_{k} = {\sum }_{i = 1}^{N} {ρ}_{k i} {\underline{B}}_{i} )$$

may be the sum of the set of basis vectors (Bᵢ) weighted by the set of parameters (Pₖ={ρₖ₁, . . . ρ_{kN}}). The correction vectors (Cₖ) and the set of N basis vectors (Bᵢ) may be sequences of the W numbers associated with the respective retention volume (vᵢ) for each of the one or more peaks. W may be a number of samples of the conditioned observed signal (Mₛ(v)) and may be represented by the following Equation:

$$W = ( {R}_{v} - {L}_{v} ) / Δ v$$

where: Rᵥ is a right limit, Lᵥ is a left limit, and Δv is the sampling resolution. The Pₖ may be the k^{th} list of N numbers specifying a weight of each basis vector (Bᵢ) in the k^{th} correction vector (Cₖ).

In at least one implementation, defining the domain may include re-convolving the one or more deconvolution candidates (S₀ᵢ(v)) based on the convolution kernel (K(σₖ, v)) to produce one or more re-convolved deconvolution candidates (R(S₀ᵢ(v))). Re-convolving the one or more deconvolution candidates (S₀ᵢ(v)) may include normalizing the one or more deconvolution candidates based on the convolution kernel (K(σₖ, v)). Defining the domain may also include generating a set of error vectors (E_{N}) for each deconvolution candidate of the one or more deconvolution candidates (S₀ᵢ(v)) based on the one or more re-convolved deconvolution candidates (R(S₀ᵢ(v))) and the conditioned observed signal (Mₛ(v)). Generating the set of error vectors (E_{N}) for each deconvolution candidate may include determining a respective residual between each re-convolved deconvolution candidate and the conditioned observed signal (Mₛ(v)). Generating the set of error vectors (E_{N}) may also include generating the set of error vectors (E_{N}) for each deconvolution candidate based on the respective residual between each re-convolved deconvolution candidate and the conditioned observed signal (Mₛ(v)). Defining the domain may also include determining the set of N basis vectors (Bᵢ) based on the set of error vectors (E_{N}). Determining the set of N basis vectors (Bᵢ) may include applying an orthonormalization process to the set of error vectors (E_{N}). The orthonormalization process may be a Gram-Schmidt orthonormalization process. Defining the domain may also include defining the domain (B) based on the set of N basis vectors (Bᵢ).

The method 3100 may also include selecting an initial deconvolution candidate signal from the one or more deconvolution candidates based on the one or more re-convolved deconvolution candidates (R(S₀ᵢ(v))), the input data, or a combination thereof, as at 3110. The initial deconvolution candidate signal may be selected based on the one or more re-convolved deconvolution candidates (R(S₀ᵢ(v))), and one or more parameters or constraints (Φ) of the input data, or a combination thereof. At least one parameter of the one or more parameters may be associated with a property of the one or more deconvolution candidates. At least one parameter of the one or more parameters may be based on a reference signal. The reference signal may be a secondary signal utilized to evaluate, stabilize, or correct a primary detector signal. The reference signal may be generated from a stable, known, or non-sample input used to verify, calibrate, or correct an output of a system or a detector thereof. The reference signal may be or form a portion of the input data. The reference signal may be based on a theoretical model. The reference signal (R₀) may be determined or calculated with a theoretical model from one or more of a known molecular weight, a known polydispersity, or any other known parameter or meta data, or any combination thereof. The reference signal (R₀) may be determined by computing a fidelity score of the initial deconvolved candidate signals S₀ᵢ(v). It should be appreciated that the initial deconvolved candidate signal may have the lowest fidelity score against the measured conditional signal Mₛ(v).

The one or more parameters or constraints (Φ) utilized to select the initial deconvolution candidate signal may be or include, but is not limited to, one or more of a relative total variation, a negative fraction, a fidelity, area conservation, a moment conservation, an excursion, curvature, a noise fraction, or the like, or any combination thereof. In at least one implementation, at least one parameter includes fidelity.

The relative total variation may be a parameter that measures how much the curve length (total variation) of a processed or deconvolved candidate signal deviates from that of the reference signal (R₀), scaled into a value between 0 and 1. It is computed by taking the absolute difference between the curve length of the deconvolution candidate signal and the reference signal, applying an exponential decay to that difference, and subtracting the result from one (1). When the deconvolved candidate signal's curve length matches the reference signal, the parameter or parameter value is zero; and as the difference grows, the parameter or parameter value approaches one. To determine the relative total variation, compute the total variation of both signals, such as by summing the absolute first-order differences across the sampled chromatogram, and then apply the exponential mapping to convert that difference into the bounded relative total variation value.

The negative fraction may be a parameter that quantifies how much of a normalized deconvolved signal lies below zero. It is determined by summing the absolute area of all negative portions of the normalized deconvolved signal and dividing that by the total absolute area of the entire normalized deconvolved signal. The resulting value may range from 0 to 1, where it is 0 when the signal contains no negative regions and increases toward 1 with increasing negative values. To determine the negative fraction, integrate the signal only over the regions where it is negative, compute the total absolute area of the full normalized signal, and take the ratio of these two quantities.

Fidelity may be a parameter that measures how closely a deconvolved candidate signal matches the conditioned measured signal after being reconvolved with the dispersion kernel of the system or the detector thereof. To determine fidelity, the candidate signal may be reconvolved with the dispersion kernel, normalized, and then subtracted from the conditioned measured signal. The absolute difference is negated, exponentiated, and subtracted from one to yield a value between 0 and 1. A fidelity value of 0 indicates a perfect match between the normalized reconvolved deconvolved candidate signal and the conditioned measured signal, while values approaching 1 indicate increasingly large discrepancies.

Area conservation may be a parameter intended to measure how closely the area of a normalized deconvolved candidate signal matches a user-specified target area. In at least one implementation, the one or more parameters omit the area conservation parameter.

Moment conservation may be a parameter that evaluates how well the deconvolved candidate signal preserves the conventional chromatographic moments of the conditioned measured signal. The conditioned signal's moments, the number-average (Mₙₛ), the weight-average (M_{ws}), and the z-average (M_{zs}), are first computed using the Yau (GPCV2) or the Hamielec method, which applies a linear calibration corrected for band broadening. The same calibration may then be used to compute the corresponding moments of the deconvolved candidate signal. For each moment, the difference between the measured-signal moment and the deconvolved-signal moment may be squared, negated, exponentiated, and subtracted from one, producing a score between 0 and 1. A score of 0 indicates perfect preservation of that moment, while values approaching 1 reflect increasing divergence.

Excursion may be a parameter that measures the overall deviation of a candidate signal from a reference signal. It may be calculated by taking the norm of the difference between the deconvolved candidate signal (S₀ᵢ(v)) and the reference signal (R₀), providing a single quantitative value that grows as the two signals diverge. When the signals closely overlap, the excursion is small; as their shapes differ more substantially, the excursion increases.

Curvature may be a parameter that quantifies how sharply a candidate signal bends or fluctuates. It may be determined by computing the second derivative of the i^{th} initial deconvolution candidate signal (S₀ᵢ(v)), squaring it, and summing these squared values across the signal. This may produce a penalty that increases when the signal exhibits strong curvature, rapid oscillations, or overly sharp features, and remains low when the signal is smooth. It should be appreciated that the curvature score may not be between 0 and 1.

Noise fraction (ω) may be a parameter that measures how much of a normalized deconvolved candidate signal is dominated by noise rather than meaningful structure. A noise threshold (η) is first computed by taking the median of the signal, determining the median absolute deviation from that median, and setting the threshold to the median plus a user-selected multiple of that deviation (typically β=2). The signal may then be split into two regions: values above the threshold, treated as true signal, and values below it, treated as noise. The noise fraction (ω) may be calculated by taking the total power of the noise region and dividing it by the total power of the signal region, yielding a value between 0 and 1. A clean signal with negligible noise produces a noise fraction near zero, while a signal dominated by noise approaches one.

In at least one implementation, one or more additional processes may be utilized to reshape or augment the objective function or adding or modifying basis vectors to a deconvoluted solution. The process may be or include, but are not limited to, one or more of PDE-based regularization, variational regularization, sparsity-inducing penalties, entropy-based regularization, graph or manifold regularization, diffusion-inspired generative methods, or the like, or any combination thereof. PDE-based regularization may include, but is not limited to, Perona-Malik anisotropic diffusion, isotropic diffusion, coherence-enhancing diffusion, edge-enhancing diffusion, or the like, or any combination thereof. The variational regularization may be or include, but is not limited to, total variation, Tikhonov regularization, Huber regularization, or the like, or any combination thereof. Sparsity-Inducing Penalties may include, but are not limited to, Lasso and Elastic net penalties. Entropy-Based Regularization may include maximum entropy methods. Graph and manifold regularization may include Laplacian regularization, Manifold Learning Constraints, or the like, or any combination thereof. Diffusion-inspired generative models may include score-based diffusion Models, stochastic PDE regularization, or the like, or any combination thereof.

In at least one implementation, selecting the initial deconvolution candidate signal (S₀(v)) from the one or more deconvolution candidates may include determining a respective composite score (ψᵢ) for each deconvolution candidate signal of the one or more deconvolution candidate signals based on the one or more parameters/constraints. Determining the respective composite score for each deconvolution candidate signal may include applying the one or more parameters/constraints to each deconvolution candidate signal of the one or more deconvolution candidate signals to produce one or more respective parameter scores. Applying each parameter of the one or more parameters to each deconvolution candidate signal may produce a respective parameter score (φᵢⱼ) of the one or more parameter scores. Determining the respective composite score for each deconvolution candidate signal may also include determining the respective composite score for each deconvolution candidate signal based on the one or more respective parameter scores. The overall score may be a sum of the respective parameter scores. The respective composite score (ψᵢ) maybe represented by the following Equation:

$${ψ}_{i} = {\sum }_{j = 1}^{l} {α}_{j} {φ}_{i j}$$

where: αⱼ may be a respective weight of each parameter of the one or more parameters and may have a value from 0 to 1, and φᵢⱼ may be the respective parameter score or constraint quantity. It should be appreciated that αⱼ may have any suitable value, such as, 1 to 100, 1 to 200, 1 to 300, or greater. The weights (αⱼ) may form a portion of the input data, such as the user-defined input. The weights (αⱼ) may configure the relative importance of the different quantities for guiding the deconvolution. The constraint quantity or parameter score (φᵢⱼ) may be a quantity that measures a physical property of a normalized deconvolution candidate signal. For example, the parameter score may measure a property (e.g., fidelity, area, etc.) of the one or more deconvolution candidate signals (S₀ᵢ(v)). The parameter quantity may have a value from 0 to 1. A value of 0 may indicate an ideal physically correct quantity, and a value of 1 may indicate a departure from the ideal physically correct quantity. In at least one implementation, selecting the initial deconvolution candidate signal (S₀(v)) from the one or more deconvolution candidate signals may also include selecting the initial deconvolution candidate signal based on the respective composite score for each deconvolution candidate signal of the one or more deconvolution candidate signals. In at least one implementation, the initial deconvolution candidate signal (S₀(v)) may be the deconvolution candidate signal having the lowest overall score, such as the lowest overall score in the set (Ψ={ψ₁, ψ₂, . . . , ψ_{N}}).

The method 3100 may also include modifying the detector based on the initial deconvolution candidate, the domain, or a combination thereof, as at 3112. Modifying the detector may include updating or modifying one or more parameters, workflows, and/or protocols of the detector based on the initial deconvolution candidate, the domain, or a combination thereof. For example, modifying the detector may include updating or modifying one or more parameters, workflows, and/or protocols of the detector based on the set of N basis vectors (Bᵢ), the plurality of correction vectors (Cₖ), the set of error vectors (E_{N}), or a combination thereof. Modifying the parameters, the workflows, and/or the protocols of the detector optimizes the detector by improving the resolution of the detector, minimizing and/or removing the effects of dispersion (e.g., band broadening) of the detector, minimizing and/or removing dispersion in the signals generated by the detector, or any combination thereof. Modifying the parameters, the workflows, and/or the protocols of the detector may also include adjusting processing steps, recalibrating baselines, updating signal-conditioning protocols, incorporating or updating models, modifying calibration parameters, or the like, or any combination thereof.

The method 3100 may also include determining an optimized signal, as at 3114. The optimized signal may be based on the initial deconvolution candidate and the set of N basis vectors (Bᵢ). Determining the optimized signal may include applying the set of N basis vectors (Bᵢ) to the initial deconvolution candidate to produce a plurality of optimized signal candidates. Determining the optimized signal may also include determining a respective candidate score (φᵢⱼ) for each optimized signal candidate of the plurality of optimized signal candidates. Determining the respective candidate score (φᵢⱼ) for each optimized signal candidate of the plurality of optimized signal candidates may include applying the one or more parameters or constraints (Φ) to each optimized signal candidate. The one or more parameters or constraints applied to the optimized signal candidates may be the same parameters as those utilized to select the initial deconvolution candidate signal. Determining the optimized signal may also include determining the optimized signal based on the respective candidate score, which may be a composite candidate score (ψᵢ) as previously discussed. The optimized signal may have the lowest candidate score.

The method 3100 may further include generating an output based on the optimized signal, as at 3116. Generating the output may include reconditioning a candidate signal based on the observed signal (M(v)), the region of interest (ROI), the optimized signal, or any combination thereof, to produce a final optimized deconvoluted signal (S_{f}(v)). Reconditioning the candidate signal may include scaling and normalizing the optimized signal. The optimized signal may be normalized and scaled based on a respective area (A) of each peak of the one or more peaks of the chromatogram of the unknown sample. The final optimized deconvoluted signal (S_{f}(v)) may be constructed by copying the original measured signal and replacing the values with the Optimized signal Sₖ(v). The originally measured signal may be copied with or without the ROI.

The method 3100 may also include displaying the output, as at 3118. Displaying the output may include displaying the optimized signal on a display or monitor.

The method 3100 may also include performing an action in response to any one or more of the foregoing steps and/or one or more portions thereof. For example, the action may be in response to configuring the detector, generating the one or more deconvolution candidate signals, defining the domain, selecting the initial deconvolution candidate signal, modifying the detector, determining the optimized or dispersion corrected signal, a portion thereof, or any combination thereof. The action may be or include generating and/or transmitting a signal that recommends, instructs, or causes a physical action to occur. In at least one implementation, the action may be or include generating a training set based on the domain, the set of N basis vectors (Bᵢ), the plurality of correction vectors (Cₖ), the set of error vectors (E_{N}), or any combination thereof. The training set may be utilized for a machine-learning or artificial intelligence (AI) model. The training set may be utilized for predicting the domain of a system or a detector thereof to thereby optimize or improve the system or the detector thereof. The action may also include conducting high throughput screening, enhancing predictive capabilities for high throughput screening.

### Data Acquisition Setup

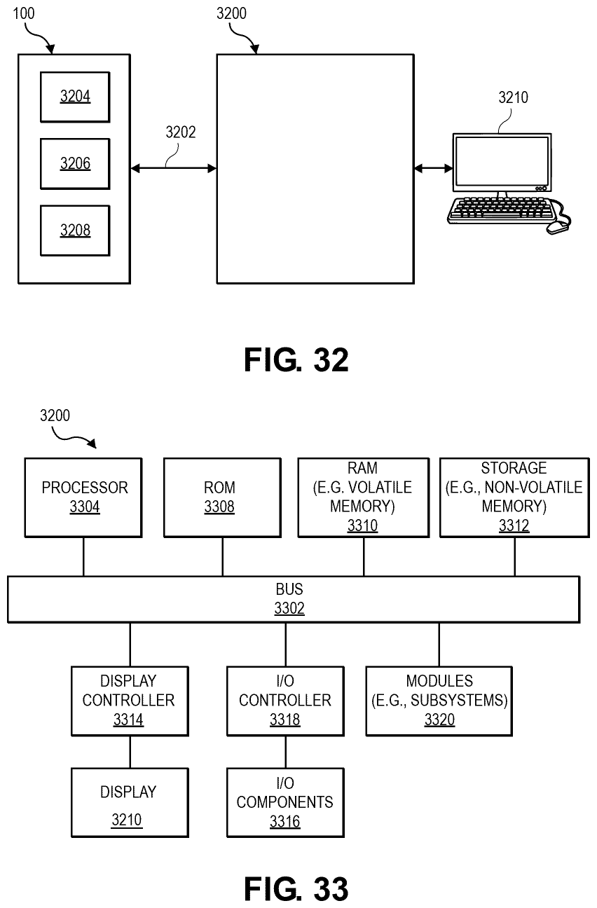

As noted above, the methods disclosed herein may operate on, use, or otherwise utilize data and/or signals (e.g., directly measured data, output measurements, output signals, etc.) in a correction process to adjust or correct for the effects of dispersion of a system, such as the system 100 of FIG. 1, including a detector having a separation media. The dispersion processes may be characterized using measurements or signals output from the system 100, such as a qualitative and/or quantitative instrument (e.g., analytical instrument). FIG. 32 illustrates a computer system or electronic processor 3200 for receiving and/or analyzing data from a system, such as the system 100 of FIG. 1, or a component thereof, according to one or more implementations disclosed. In at least one implementation, the computer system 3200 of FIG. 32 may be utilized in lieu of or in addition to the computer 106 of FIG. 1. For example, the computer system or electronic processor 3200 may receive and/or analyze data or signals 3202 from the system 100, and the system 100 may be capable of or configured to output the data or signals 3202. The computer system or electronic processor 3200 may be a general purpose computer, and may allow a user (e.g., chromatographer) to process data, analyze data, interpret data, store data, retrieve data, display data, display results, interpret results, store results, or any combination thereof. The results may be graphical in form and/or tabular in form. It should be appreciated that the electronic processor 3200 may be operably and/or communicably coupled with any suitable system known in the art that utilizes a detector and a separation media, such as a packed bed, including, but not limited to, a chromatography system/instrument (e.g., HPLC, GPC, etc.).

The computer system or electronic processor 3200 may be capable of or configured to operate, communicate with (e.g., send/receive data), modify, modulate, or otherwise run any one or more components of the system 100. For example, the electronic processor 3200 may be operably and/or communicably coupled with and capable of or configured to operate, communicate with, modify, modulate, or otherwise run a component of the system 100. Illustrative components may be or include, but are not limited to, one or more of a pump, a light source (e.g., laser), a sample source, one or more detectors, or the like, or any combination thereof.

In at least one implementation, the electronic processor 3200 may be operably and/or communicably coupled with one or more components 3204, 3206, 3208 of the system 100, and capable of or configured to send and/or received signals and/or data 3202 therefrom. The data 3202 from the one or more components 3204, 3206, 3208 may be or include analog data, such as fluctuating analog voltage, digital data, or the like, or any combination thereof. In at least one implementation, the electronic processor 3200 may be capable of or configured to convert the analog data to digital data. For example, the electronic processor 3200 may include an analog to digital converter (not shown). In another implementation, an analog to digital converter may be interposed between the system 100 or the components 3204, 3206, 3208 thereof and the electronic processor 3200.

The electronic processor 3200 may be capable of or configured to receive, collect, record, and/or store data 3202 from any one or more components 3204, 3206, 3208 of the system 100. For example, the electronic processor 3200 may receive data 3202 from the one or more components 3204, 3206, 3208 of the system 100, optionally convert the data 202, and record and/or store the data 202 in a computer memory, such as a local drive or network drive (e.g., cloud drive).

The electronic processor 3200 may be capable of or configured to analyze, process, display, and/or output data 3202. For example, the electronic processor 3200 may include software capable of or configured to analyze, process, display, and/or output data 3202. The software may also be capable of or configured to process the data 3202 and output or display the data 3202 on a workstation or display 3210. The software may include any one or more of the algorithms, equations, methods, steps, processes, and/or formulas disclosed herein. The electronic processor 3200 may process and/or extract information from the data 3202 to prepare results, and present the data 3202 and/or the results, such as in a report or on the display 204. The electronic processor 3200 may include a graphical user interface (GUI) that allows a user or the chromatographer to interact with all systems, subsystems, and/or components of the electronic processor 3200 and/or the system 100.

FIG. 33 illustrates a block diagram of the computer system or electronic processor 3200 of FIG. 32 that may be used in conjunction with the system 100, and/or one or more methods disclosed herein, according to one or more implementations disclosed. For example, the computing system 3200 (or system, or server, or computing device, or device) may represent any of the devices or systems described herein that perform any of the processes, operations, or methods of the disclosure. Note that while the computing system 3200 illustrates various components, it is not intended to be limited to any particular architecture or manner of interconnecting the components as such details are not germane to the present disclosure. It will also be appreciated that other types of systems that have fewer or more components than shown may also be used with the present disclosure.

As shown, the computing system 3200 may include a bus 3302 which may be coupled to a processor 3304, ROM (Read Only Memory) 3308, RAM (or volatile memory) 3310, and storage (or non-volatile memory) 3312. The processor 3304 may store data 3202 in one or more of the memories 3308, 3310, 3312. The processor 3304 may also retrieve stored data from one or more of the memories 3308, 3310, and 3312. The one or more memories 3308, 3310, 3312 may store the software disclosed therein, which may include instructions to perform any one or more of the processes, operations, or methods described herein. The processor 3304 may also retrieve stored software or the instructions thereof from one or more of the memories 3308, 3310, and 3312 and execute the instructions to perform any one or more of the processes, operations, or methods described herein. These memories represent examples of a non-transitory computer-readable medium (or machine-readable medium) or storage containing instructions which when executed by a processor 3304 (or system, or computing system), cause the processor 3304 to perform any one or more of the processes, operations, or methods described herein. The RAM 3310 may be implemented as, for example, dynamic RAM (DRAM), or other types of memory that require power continually in order to refresh or maintain the data in the memory. Storage 3312 may include, for example, magnetic, semiconductor, tape, optical, removable, non-removable, and/or other types of storage that maintain data even after power is removed from the computer system 3200. It should be appreciated that storage 3312 may be remote from the system 3200 (e.g., accessible via a network).

A display controller 3314 may be coupled to the bus 3302 in order to receive data to be displayed on the display 3210, which may display any one of the user interface features or implementations described herein and may be a local or a remote display device 3210. The computing system 3200 may also include one or more input/output (I/O) components 3316 including mice, keyboards, touch screen, network interfaces, printers, speakers, other devices, or the like, or any combination thereof. Typically, the input/output components 3316 are coupled to the system 3200 through an input/output controller 3318.

Modules 3320 (or program code, instructions, components, subsystems, units, functions, or logic) may represent any of the instructions, subsystems, steps, methods, equations, calculations, plots, or engines described above. Modules 3320 may reside, completely or at least partially, within the memories described above (e.g., non-transitory computer-readable media), or within a processor 3304 during execution thereof by the computing system 3200. In addition, Modules 3320 may be implemented as software, firmware, or functional circuitry within the computing system 3200, or as combinations thereof.

The present disclosure has been described with reference to exemplary implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof.

1. A method for modifying a system comprising a detector and a calibrated separation media operably coupled with one another, the method comprising:
obtaining input data from the detector, wherein the input data comprises an observed signal of an unknown sample and a signal of at least one known sample;
generating one or more deconvolution candidate signals based on the observed signal and using one or more deconvolution processes;
defining a domain of the detector using the one or more deconvolution processes and based on the observed signal, the calibrated separation media, the input data, or a combination thereof; and
modifying the system based on the domain.

2. The method of claim 1, further comprising:
reconvolving the one or more deconvolution candidate signals based on the input data, the calibrated separation media, or a combination thereof, to produce one or more reconvolved deconvolution candidate signals;
selecting an initial deconvolution candidate signal from the one or more deconvolution candidate signals based on the one or more reconvolved deconvolution candidate signals, the input data, or a combination thereof; and
modifying the system based on the initial deconvolution candidate and the domain.

3. The method of claim 1, further comprising:
generating a conditioned observed signal of the unknown sample by applying, to the observed signal of the unknown sample, a baseline correction, a filtering operation, a normalization operation, or a combination thereof, wherein:
the one or more deconvolution candidate signals are based on the conditioned observed signal and using the one or more deconvolution processes;
the domain of the detector is defined based on the conditioned observed signal, the calibrated separation media, the input data, or a combination thereof;
reconvolving the one or more deconvolution candidate signals based on the input data, the calibrated separation media, or a combination thereof, to produce one or more reconvolved deconvolution candidate signals;
selecting an initial deconvolution candidate signal from the one or more deconvolution candidate signals based on the one or more reconvolved deconvolution candidate signals, the input data, or a combination thereof; and
modifying the detector based on the initial deconvolution candidate signal and the domain.

4. (canceled)

5. The method of claim 1, wherein defining the domain of the detector comprises reconvolving the one or more deconvolution candidate signals based on the calibrated separation media to produce one or more reconvolved deconvolution candidate signals.

6. The method of claim 5, wherein defining the domain further comprises generating a set of error vectors for each deconvolution candidate signal of the one or more deconvolution candidate signals based on the one or more reconvolved deconvolution candidate signals and the observed signal.

7. The method of claim 6, wherein generating the set of error vectors for each deconvolution candidate signal comprises:
determining a respective residual between each reconvolved deconvolution candidate signal and the observed signal; and
generating the set of error vectors for each deconvolution candidate signal based on the respective residual between each reconvolved deconvolution candidate signal and the conditioned observed signal.

8. The method of claim 6, wherein defining the domain further comprises determining a set of N basis vectors (Bᵢ) based on the set of error vectors (E_{N}).

9. The method of claim 8, wherein determining the set of N basis vectors (Bᵢ) comprises applying an orthonormalization process to the set of error vectors (E_{N}).

10. The method of claim 8, wherein defining the domain further comprises determining a plurality of correction vectors (Cₖ) based on the set of N basis vectors (Bᵢ), the set of error vectors (E_{N}), or a combination thereof.

11. The method of claim 10, wherein defining the domain further comprises defining the domain based on the set of N basis vectors (Bᵢ), the plurality of correction vectors (Cₖ), or a combination thereof.

12. The method of claim 1, wherein modifying the system comprises updating a parameter or protocol of the detector based on the domain.

13. (canceled)

14. The method of claim 2, wherein the domain comprises a multidimensional domain defined by an N-dimensional vector space comprising a plurality of correction vectors, and wherein defining the domain comprises:
generating a set of error vectors for each deconvolution candidate signal of the one or more deconvolution candidate signals based on the one or more reconvolved deconvolution candidate signals and the observed signal;
determining a set of N basis vectors for each deconvolution candidate signal of the one or more deconvolution candidate signals based on the respective set of error vectors thereof; and
defining the domain based on set of N basis vectors.

15. (canceled)

16. The method of claim 14, wherein defining the domain further comprises:
determining a plurality of correction vectors based on the set of N basis vectors; and
defining the domain based on the plurality of correction vectors.

17-20. (canceled)

21. The method of claim 14, wherein the plurality of correction vectors (Cₖ) are represented by Equation (1):
$${\underline{C}}_{k} = {\sum }_{i = 1}^{N} {ρ}_{k i} {B}_{i} , \qquad ( 1 )$$
wherein:
ρₖᵢ is a set of weighting parameters; and
Bᵢ is the set of N basis vectors.

22-29. (canceled)

30. The method of claim 2, wherein selecting the initial deconvolution candidate signal comprises determining a respective composite score for each deconvolution candidate signal of the one or more deconvolution candidate signals based on the input data.

31. The method of claim 30, wherein the input data comprises one or more user-defined inputs, and wherein the respective composite score for each deconvolution candidate signal of the one or more deconvolution candidate signals is based on the one or more user-defined inputs.

32. The method of claim 2, wherein the initial deconvolution candidate signal is selected based on at least one constraint associated with a property of the one or more deconvolution candidate signals.

33. The method of claim 32, wherein at least one constraint of the one or more deconvolution candidate signals is fidelity.

34-40. (canceled)

41. The method of claim 2, wherein selecting the initial deconvolution candidate signal from the one or more deconvolution candidate signals comprises:
determining a respective fidelity of each deconvolution candidate signal based on the one or more reconvolved deconvolution candidate signals; and
selecting the initial deconvolution candidate signal based on the respective fidelity for each deconvolution candidate signal of the one or more deconvolution candidate signals.

42. (canceled)

43. (canceled)

44. A method for determining a dispersion corrected signal from a detector comprising a separation media, the method comprising:
obtaining input data comprising an observed signal of an unknown sample from the detector;
configuring the detector based on the input data to produce a calibrated separation media and a conditioned observed signal;
generating one or more deconvolution candidate signals based on the conditioned observed signal and using one or more deconvolution processes;
defining a domain of the dispersion corrected signal using the one or more deconvolution processes and based on the conditioned observed signal, the calibrated separation media, the input data, or a combination thereof;
reconvolving the one or more deconvolution candidate signals based on the input data, the calibrated separation media, or a combination thereof, to produce one or more reconvolved deconvolution candidate signals;
selecting an initial deconvolution candidate signal from the one or more deconvolution candidate signals based on the one or more reconvolved deconvolution candidate signals, the input data, or a combination thereof; and
determining the dispersion corrected signal based on the initial deconvolution candidate and the domain.
